(19) United States
(12) Patent Application Publication
(10) Pub. No.: US 2022/0256831 A1
(43) Pub. Date: Aug. 18, 2022

(54) HORSESHOE AND HORSESHOE ATTACHMENTS

(71) Applicant: Plastic Horseshoes Pty Ltd, Northgate, Queensland (AU)

(72) Inventor: Steve COSTIN, VERESDALE, Queensland (AU)

(21) Appl. No.: 16/322,534

(22) PCT Filed: Aug. 4, 2017
(86) PCT No.: PCT/AU2017/050825

§ 371 Date: Feb. 1, 2019

(30) Foreign Application Priority Data
Aug. 4, 2016 (AU) 2016903067
Sep. 8, 2016 (AU) 2016903611
May 11, 2017 (AU) 2017901743

(51) Int. Cl. A01L 1/04; A01L 3/02

(52) U.S. Cl. CPC A01L 1/04; A01L 3/02

(57) ABSTRACT

A horseshoe for flexible and/or mouldable engagement with a hoof is provided. Also provided is a horseshoe attachment for engagement with a horseshoe. The horseshoe and the attachment will have respective bodies comprising a bridge connecting two legs. The horseshoe and the horseshoe attachment may each be of unitary construction. The horseshoe and the horseshoe attachment may each be formed of polyurethane, or a material comprising polyurethane. Methods of shoeing a hoof using the horseshoe and/or attaching the horseshoe attachment to a horseshoe are also provided.

### FIELD OF THE INVENTION

The present invention relates to equipment for attachment to the hoof of an animal. More particularly, the invention relates to a horseshoe. The invention also relates to attachments for a horseshoe.

### BACKGROUND OF THE INVENTION

Conventional horseshoes are attached to the hoof of a horse to protect the hoof from wear.

Typically, horseshoes are constructed from metal. Such metallic horseshoes are typically relatively rigid, and impede the shock absorbing ability of the hoof, including natural flexing and widening that occurs when under load, e.g. when in contact with the ground during movement of the horse.

Inhibition of shock absorbing ability of the hoof is undesirable for several reasons. For example, this can contribute to lameness of the horse, and/or damage to the hoof. While some variations of conventional horseshoes with respect to materials and/or form exist which attempt to offset impediment to shock absorption caused by the shoe, such horseshoes generally have significant shortfalls or disadvantages. In particular, some existing plastic horseshoes, while providing some capacity to flex with and/or mould to a horse's foot, are not optimized for this purpose.

Additionally, conventional horseshoes provide a substantially generic or ‘non-adapted’ base for contact with the ground, e.g. a flat surface, or a simple pattern of ridges. While this base may be suitable for general use, in some circumstances an adapted base may be preferred or required, for example particular treads can be desirable for traverse of wet, snowy, or muddy terrain, and for specific activities (including sports, such as racing and polo). Furthermore, particular bases can be desirable for treatment or prevention of certain conditions in a horse. By way of example, bases offering protection of, and/or supported against the frog of a horses foot may be desirable to treat or prevent lameness.

While horseshoes with bases specifically adapted for certain applications exist, changing between such horseshoes typically requires removal and replacement of entire shoes. Not only does this have disadvantages with respect to convenience and efficiency, frequent changing of shoes can cause injury to the horse and/or damage to the hoof, particularly where mechanical fastening of the shoes is used.

Although horseshoes are conventionally constructed of metal, as noted above, some plastic horseshoes exist. However, one disadvantage of conventional plastic horseshoes in comparison to metal horseshoes is that such plastic horseshoes are generally more prone to wear and damage in use. This can result in a requirement for relatively frequent replacement of plastic shoes, which can result in injury to the horse and/or damage to the hoof.

### SUMMARY OF INVENTION

In a first aspect, the invention is directed to a horseshoe for flexible and/or mouldable engagement with a hoof. The hoof may be of any suitable animal. Preferably, the hoof is of a horse.

Preferably, a body of the horseshoe comprises at least two legs connected by a bridge.

The bridge will comprise a mid-portion located between the legs. The legs will comprise ends located distal from the bridge.

Suitably, a longitudinal axis of the horseshoe passes through the mid-portion of the bridge and extends in a first plane. Preferably, the horseshoe is substantially symmetrical about the longitudinal axis.

Preferably, the legs extend inwardly towards the longitudinal axis.

In preferred embodiments, the bridge is an arcuate bridge. Suitably, the arcuate bridge comprises a peak at the mid-portion.

In some embodiments, the average width of the bridge is greater than the average width of each of the two legs.

In certain preferred embodiments wherein the bridge is an arcuate bridge, the width of the horseshoe decreases from the peak of the arcuate bridge, to the ends of the legs.

Suitably, the body of the horseshoe comprises an ‘upper’ or ‘hoof-engaging’ face, and a ‘lower’ or ‘ground-engaging’ face. The upper and lower faces will have an outer edge and an inner edge. Preferably, the upper and lower faces have respective edges at the ends of each of the legs.

The body of the horseshoe will have a maximum length along the longitudinal axis. In some embodiments, the ratio of the average width of the bridge to the maximum length of the body is about 0.1 to about 0.4. Preferably, said ratio of the average width of the bridge to the maximum length of the body is greater than about 0.25.

The body of the horseshoe will have a maximum width between points at the outer edges which are a maximum distance apart in a direction perpendicular to the longitudinal axis of the horseshoe. Preferably, the ratio of the average width of the legs to the maximum width of the body is about 0.25. In some embodiments, said ratio is between about 0.15 and about 0.35.

The horseshoe will have an average thickness along a second plane perpendicular to the first plane containing the longitudinal axis of the horseshoe. Preferably, the ratio of the average thickness of the body of the horseshoe, to the average width of the bridge, is less than about 0.5. In some preferred embodiment, said ratio is less than about: 0.4; 0.3; 0.2; or 0.1.

In some embodiments, a portion of the upper face of the horseshoe is inclined downwardly towards the inner edge.

In some embodiments, the upper face of the horseshoe is substantially flat.

In embodiments, the lower face of the horseshoe comprises one or more protrusions and/or indentations. Preferably, the protrusions and/or indentations comprise protrusions and/or indentations for providing traction in use.

In certain embodiments, at a portion flanking the mid-point of the bridge, the lower face is inclined to facilitate pivoting of the horseshoe about the outer edge.

In certain embodiments, at the ends of the legs, the lower face of the horseshoe is inclined to facilitate pivoting of the horseshoe about the ends of the legs.

In certain embodiments, a portion of the lower face is inclined upwardly towards the inner edge. Preferably, said portion is in the form of a chamfer extending along the bridge. Optionally, said chamfer may extend at least part way along each of the respective legs.

In certain embodiments, the body of the horseshoe comprises one or more apertures or channels extending between the lower and upper faces. Preferably, the apertures or channels are located proximal to the outer edges. Preferably, the apertures comprise a series of spaced apertures or channels arranged along each of the legs and/or the bridge.

Preferably, the horseshoe comprises clips extending from the upper face of the horseshoe, and located at or near the outer edge of the horseshoe. In preferred such embodiments, the horseshoe comprises a clip at or near the mid-point of the bridge; and one or more pairs of clips located along the bridge and/or the respective legs.

In certain embodiments, the lower face of the horseshoe comprises one or more indentations for connection of an attachment. Preferably, the lower face comprises indentations located near to the ends of the legs. In some embodiments, the lower face comprises an indentation located substantially in line with the mid-point of the bridge.

Preferably, the body of the horseshoe is formed from a material having a hardness of between 55 D and 85 D as measured using durometer scale. More preferably, said hardness is between about 60 D and about 80 D. In some particularly preferred embodiments, said hardness is between about 67 D and about 77 D.

Preferably, the horseshoe is of unitary construction.

Preferably, the horseshoe is formed from a plastic material, such as polyurethane, or a material comprising polyurethane.

In a second aspect, the invention provides an attachment for a horseshoe.

Preferably, the attachment is capable of flexible and/or mouldable engagement of a horseshoe.

Preferably, a body of the attachment comprises two legs connected by a bridge.

The bridge will comprise a mid-portion located between the legs. The legs will comprise ends located distal from the bridge.

Suitably, a longitudinal axis of the attachment passes through the mid-portion of the bridge and extends in a first plane. Preferably, the attachment is substantially symmetrical about the longitudinal axis.

Preferably, the legs extend inwardly towards the longitudinal axis.

In preferred embodiments, the bridge is an arcuate bridge. Suitably, the arcuate bridge comprises a peak at the mid-portion.

In some embodiments, the average width of the bridge is greater than the average width of each of the two legs.

In certain preferred embodiments wherein the bridge is an arcuate bridge, the width of the attachment decreases from the peak of the arcuate bridge, to the ends of the legs.

Suitably, the attachment comprises an ‘upper’ or ‘horseshoe-engaging’ face, and a ‘lower’ or ‘ground-engaging’ face. The upper and lower faces will have an outer edge, and an inner edge. Preferably, the upper and lower faces will have respective edges at the ends of each of the legs.

The body of the attachment will have a maximum total length along the longitudinal axis. In some embodiments, the ratio of the average width of the bridge to the maximum length of the body is about 0.1 to about 0.4. Preferably, said ratio of the average width of the bridge to the maximum length of the body is greater than about 0.25.

The body of the attachment will have a maximum total width between points at the outer edges which are a maximum distance apart in a direction perpendicular to the longitudinal axis of the attachment. Preferably, the ratio of the average width of the legs to the maximum total width of the body is about 0.25. In some embodiments, said ratio is between about 0.15 and about 0.35.

The attachment will have an average thickness along a second plane perpendicular to the first plane containing the longitudinal axis of the attachment. Preferably, the ratio of the average thickness of the body of the attachment, to the average width of the bridge, is less than about 0.5. In some preferred embodiments, said ratio is less than about 0.4; 0.3; 0.2; or 0.1.

In certain embodiments, the upper face of the attachment comprises one or more protrusions and/or indentations for engagement with a corresponding face of a horseshoe. Suitably, the corresponding face of the horseshoe is a lower face of the horseshoe.

The one or more protrusions may comprise a protrusion located in line with the mid-point of the bridge, for engagement with a corresponding face of a horseshoe. Preferably, the one or more protrusions comprises protrusions located near to the ends of the legs located distal to the bridge, for engagement with a corresponding face of a horseshoe.

In some embodiments of the attachment particularly adapted for connection to a horseshoe wherein a portion of the lower face of the horseshoe is inclined upwardly towards the inner edge, a portion of the upper face of the attachment may be suitably inclined to lie against the portion of the lower face of the horseshoe when connected.

In an embodiment, the lower face of the attachment is substantially flat.

In certain other embodiments, the lower face of the attachment comprises one or more protrusions and/or indentations. In certain embodiments the protrusions and/or indentations comprise protrusions and/or indentations for providing traction in use.

In some preferred embodiments, the lower face of the attachment is arcuate in longitudinal section.

In certain embodiments, at a portion flanking the mid-point of the bridge, the lower face is inclined to facilitate pivoting of the attachment about the outer edge.

In certain embodiments, at the ends of the legs, the lower face of the attachment is inclined to facilitate pivoting of the attachments about the ends of the legs.

Preferably the body of the attachment is formed from a material having a hardness between 55 D and 85 D as measured using durometer scale. More preferably, said hardness is between about 60 D and about 80 D. In some particularly preferred embodiments, said hardness is between about 67 D and about 77 D.

Preferably, the body of the attachment is of unitary construction.

Preferably, the body of the attachment is formed from a plastic material, such as polyurethane, or a material comprising polyurethane.

In some embodiments, the attachment comprises a stabilizing portion connected to the body. Suitably, the stabilizing portion is located between the legs of the body. Preferably, the stabilizing portion links respective ends of the legs of the attachment. Preferably, the stabilizing portion extends towards the bridge of the attachment.

Preferably the average thickness of the stabilizing portion is greater than the average thickness of the body of the attachment. In preferred embodiments, the ratio of the average thickness of the stabilizing portion to the average thickness of the body is greater than about 2.

In preferred embodiments, the body and the stabilizing portion are of unitary construction.

In a third aspect, the invention provides an assembly of a horseshoe and a horseshoe attachment.

Preferably, the horseshoe is a horseshoe of the first aspect. Preferably, the attachment is an attachment of the second aspect.

Suitably, protrusions of the upper face of the attachment for engagement with a corresponding face of a horseshoe are inserted into indentations of the lower face of the horseshoe for connection of an attachment.

In preferred embodiments, the one or more protrusions and/or indentations of the upper face of the attachment engage with corresponding protrusions and/or indentations of the lower face of the horseshoe for providing traction in use.

In a fourth aspect, the invention provides a method of shoeing a hoof, including the step of fastening a horseshoe of the first aspect to a hoof, to thereby shoe the hoof.

In one embodiment, the step of fastening the horseshoe to the hoof comprises mechanically fastening the horseshoe to the hoof. In preferred such embodiments wherein the horseshoe comprises one or more apertures or channels extending from the lower face of the horseshoe to the upper face of the horseshoe, one or more mechanical fasteners are placed through the one or more apertures or channels into the hoof, to thereby mechanically fasten the horseshoe to the hoof.

The step of fastening the horseshoe to the hoof may additionally or alternatively comprise fastening using a chemical fastener or adhesive.

In one embodiment, the method includes the further step of applying a shock absorbing material between the horseshoe and the hoof. Preferably, the shock absorbing material is applied through an aperture or channel in the horseshoe.

In a fifth aspect, the invention provides a method of connecting a horseshoe attachment, including the step of fastening an attachment of the second aspect to a horseshoe, to thereby connect the horseshoe attachment.

Preferably, the horseshoe to which the attachment is connected is a horseshoe of the first aspect.

In some preferred embodiments, the fastening of the horseshoe comprises fastening using a chemical fastener or adhesive.

The fastening of the horseshoe may additionally or alternatively comprise mechanical fastening.

A related aspect provides a method of replacing a horseshoe attachment, including the steps of: (i) removing a horseshoe attachment of the second aspect from a horseshoe; and (ii) fastening a horseshoe attachment of the second aspect to the horseshoe.

In a sixth aspect, the invention provides a method of fastening a horseshoe assembly to a hoof, including the steps of (i) fastening a horseshoe of the first aspect to a hoof; and (ii) fastening a horseshoe attachment of the second aspect to the horseshoe.

In a preferred embodiment, fastening as per step (i) is mechanical fastening. In a preferred embodiment, fastening as per step (ii) is chemical fastening.

In a seventh aspect, there is provided a method of preventing or treating a disease, condition, or disorder in an animal, including the step of shoeing a hoof of the animal according to the fourth aspect; connecting a horseshoe attachment to a horseshoe with which a hoof of the animal has been shoed according to the fifth aspect; or fastening a horseshoe assembly to a hoof of the animal according to the sixth aspect, to thereby prevent or treat the disease, condition, or disorder in the animal.

In embodiments, the disease, condition, or disorder according to the seventh aspect is of the leg and/or hoof of the horse. In preferred embodiments, said disease, condition, or disorder is selected from the group consisting of lameness; leg soreness including front leg soreness and/or rear leg soreness; shin soreness; heal soreness; and poor hoof condition.

In embodiments, the disease, condition, or disorder according to the seventh aspect is an adverse temperament and/or behaviour. In an embodiment, said adverse temperament is irritability and/or aggression. In an embodiment, said behaviour is an adverse gait. In an embodiment, said adverse gait is or includes jarring up.

In an eighth aspect, there is provided a method of improving performance in a racing or eventing animal, including the step of shoeing a hoof of the animal according to the fourth aspect; connecting a horseshoe attachment to a horseshoe with which a hoof of the animal has been shoed according to the fifth aspect; or fastening a horseshoe assembly to a hoof of the animal according to the sixth aspect, to thereby improve performance in the racing animal.

Suitably, the performance that is improved according to the method of the eighth aspect is racing or eventing performance. In one preferred embodiment, the racing performance is racing performance on hard and/or dry tracks. Said racing performance may additionally or alternatively be racing performance on soft and/or wet tracks.

### BRIEF DESCRIPTION OF THE DRAWINGS

FIG. 1 provides a perspective view of an upper face of an embodiment of a horseshoe of the invention. This embodiment may be referred to as a ‘Design 1, front hoof’ horseshoe.

FIG. 2 provides a perspective view of a lower face of the horseshoe in FIG. 1.

FIG. 3 provides a perspective view of an upper face of another embodiment of a horseshoe of the invention. This embodiment may be referred to as a ‘Design 1, rear hoof’ horseshoe.

FIG. 4 provides a perspective view of a lower face of the horseshoe in FIG. 3.

FIG. 5 provides a perspective view of an upper face of an embodiment of an attachment of the invention. This embodiment may be referred to as a ‘Design 1, rocker’ attachment.

FIG. 6 provides a perspective view of a lower face of an embodiment of the attachment in FIG. 5.

FIG. 7 provides: (A) a perspective view; and (B) a side view, of the attachment in FIG. 5 connected to the horseshoe in FIG. 1.

FIG. 8 provides a perspective view of an upper face of an embodiment of an attachment of the invention. This embodiment may be referred to as a ‘Design 1, heart bar’ attachment.

FIG. 9 provides a perspective view of a lower face of the attachment in FIG. 8.

FIG. 10 provides: (A) a perspective view; and (B) a side view, of the attachment in FIG. 8 connected to the horseshoe in FIG. 1.

FIG. 11 provides a perspective view of an upper face of another embodiment of a horseshoe of the invention. This embodiment may be referred to as a ‘Design 2, front hoof’ horseshoe.

FIG. 12 provides a perspective view of a lower face of the horseshoe in FIG. 11.

FIG. 13 provides a perspective view of an upper face of another embodiment of a horseshoe of the invention. This embodiment may be referred to as a ‘Design 2, rear hoof’ horseshoe.

FIG. 14 provides a perspective view of a lower face of the horseshoe in FIG. 13.

FIG. 15 provides a perspective view of an upper face of an embodiment of another attachment of the invention. This embodiment may be referred to as a ‘Design 2, heart bar’ attachment.

FIG. 16 provides a perspective view of a lower face of the attachment in FIG. 15.

FIG. 17 provides: (A) a perspective view; and (B) a side view, of the attachment in FIG. 15 connected to the horseshoe in FIG. 11.

FIG. 18 provides a perspective view of an upper face of another embodiment of an attachment of the invention. This embodiment may be referred to as a ‘Design 2, rocker’ attachment.

FIG. 19 provides a perspective view of a lower face of the attachment in FIG. 18.

FIG. 20 provides: (A) a perspective view; and (B) a side view, of the attachment in FIG. 18 connected to the horseshoe in FIG. 11.

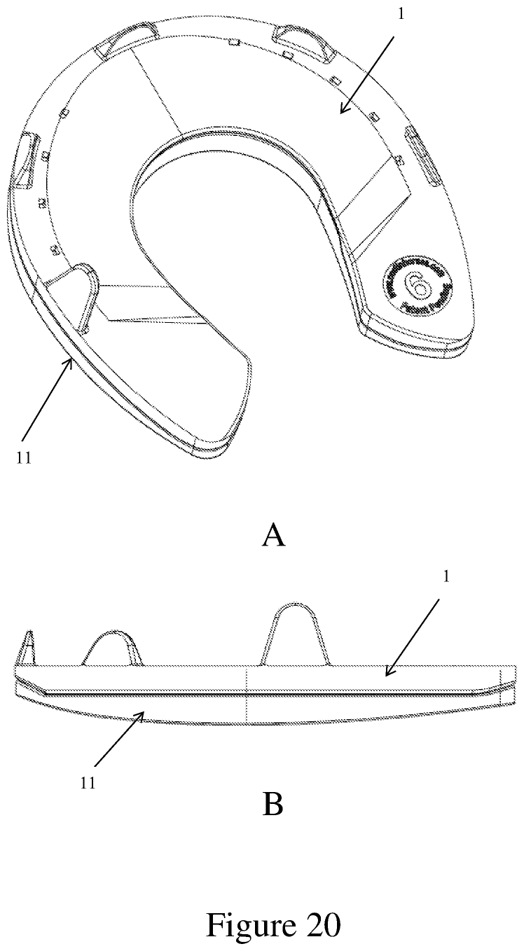

FIG. 21 provides a perspective view of an upper face of another embodiment of a horseshoe of the invention. This embodiment may be referred to as a ‘Design 3, front hoof’ horseshoe.

FIG. 22 provides a perspective view of a lower face of the horseshoe in FIG. 21.

FIG. 23 provides a perspective view of an upper face of another embodiment of a horseshoe of the invention. This embodiment may be referred to as a ‘Design 3, rear hoof’ horseshoe.

FIG. 24 provides a perspective view of a lower face of the horseshoe in FIG. 23.

FIG. 25 provides a perspective view of an upper face of an embodiment of another attachment of the invention. This embodiment may be referred to as a ‘Design 3, heart bar’ attachment.

FIG. 26 provides a perspective view of a lower face of the attachment in FIG. 25.

FIG. 27 provides: (A) a perspective view; and (B) a side view, of the attachment in FIG. 25 connected to the horseshoe in FIG. 21.

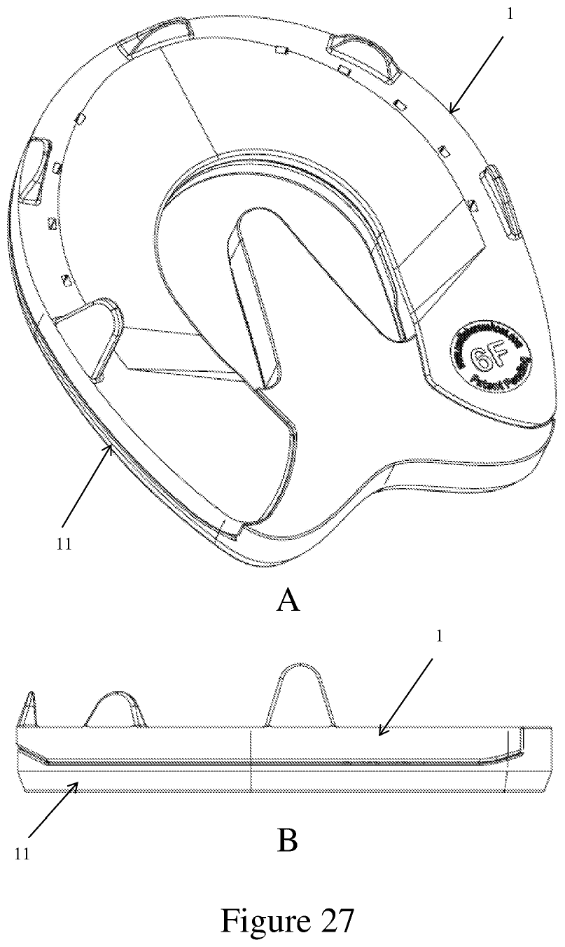

FIG. 28 provides a perspective view of an upper face of another embodiment of an attachment of the invention. This embodiment may be referred to as a ‘Design 3, rocker’ attachment.

FIG. 29 provides a perspective view of a lower face of the attachment in FIG. 28.

FIG. 30 provides: (A) a perspective view; and (B) a side view, of the attachment in FIG. 28 connected to the horseshoe in FIG. 21.

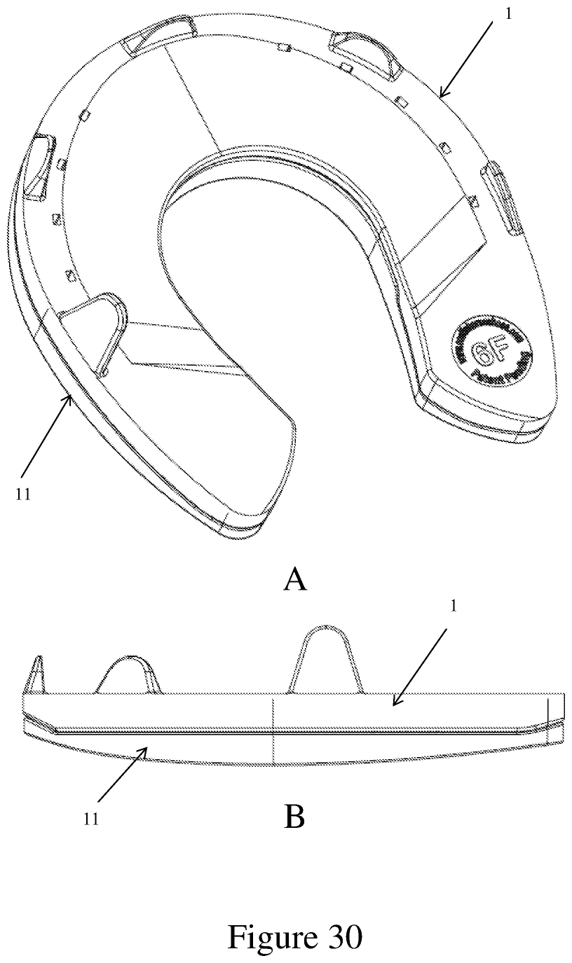

### DETAILED DESCRIPTION OF THE DRAWINGS

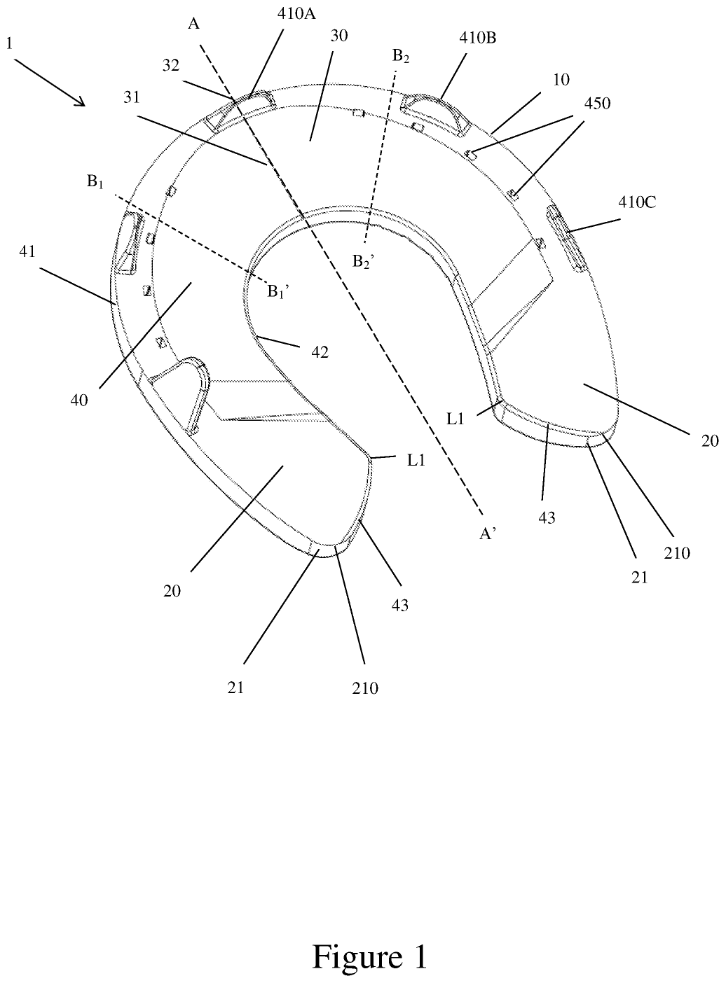

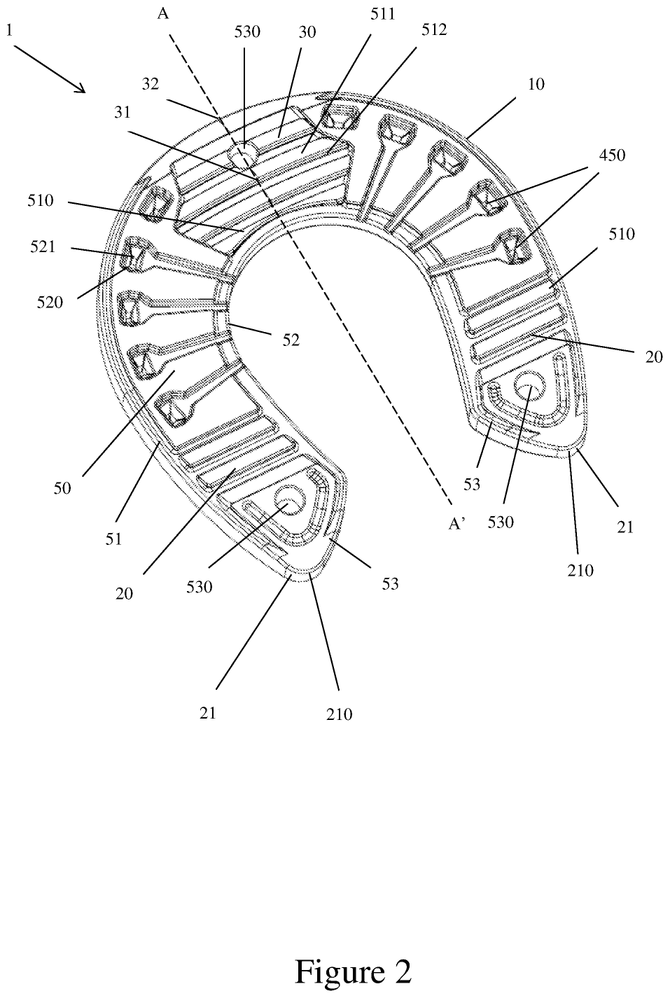

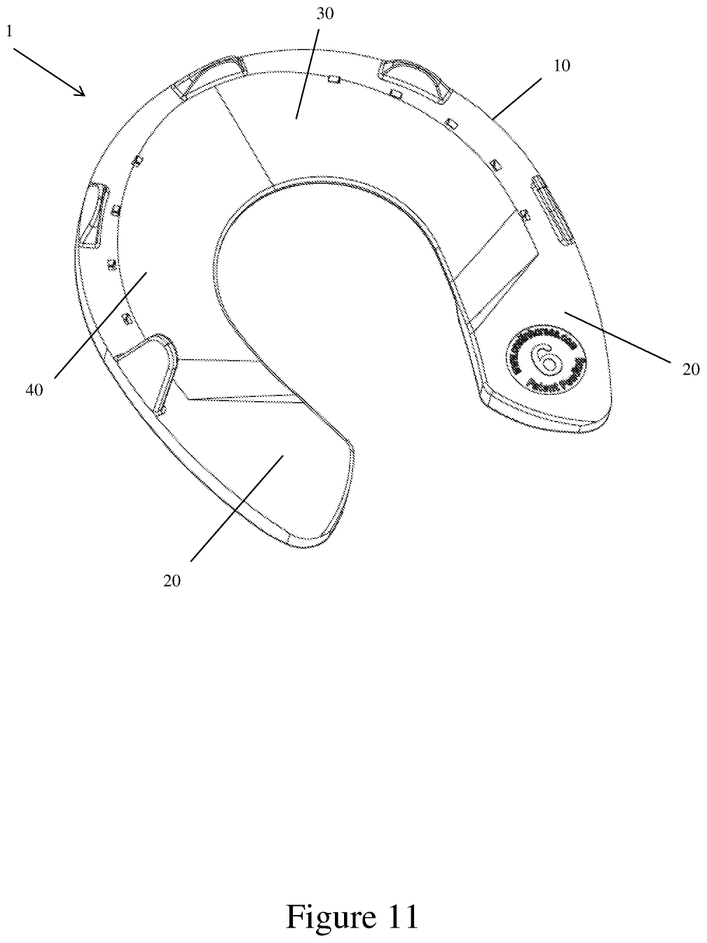

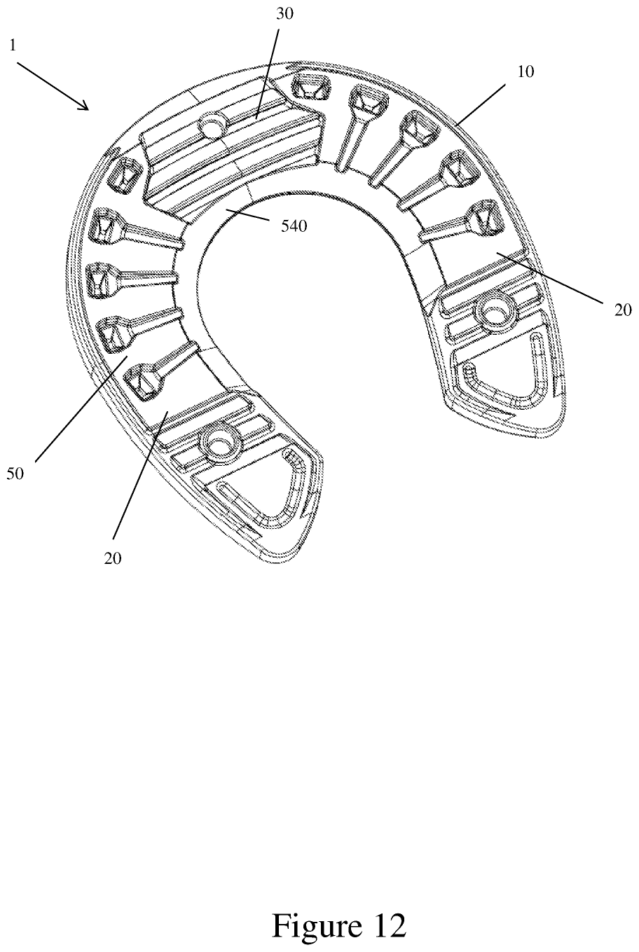

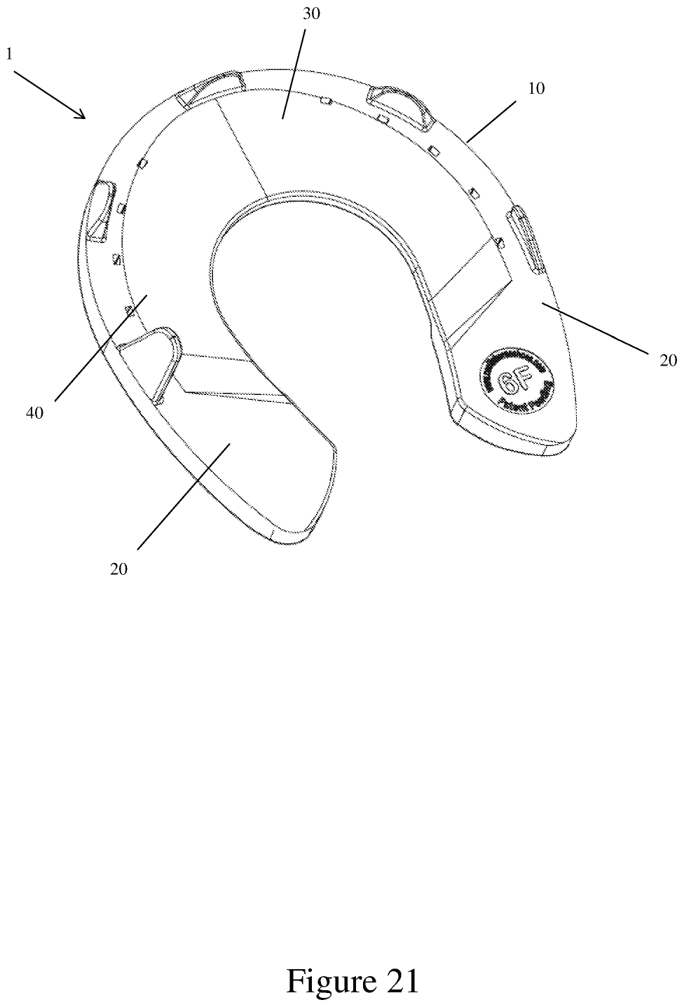

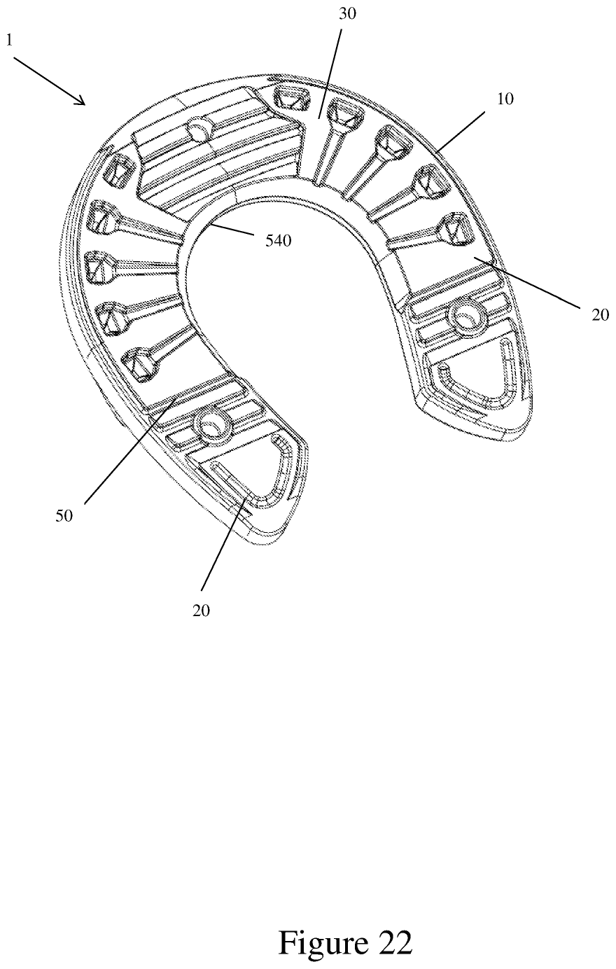

FIGS. 1 and 2 illustrate an embodiment of a horseshoe 1 according to the invention. FIGS. 11 and 12 illustrate another embodiment of a horseshoe according to the invention. FIGS. 21 and 22 illustrate another embodiment of a horseshoe according to the invention. The embodiments depicted in FIGS. 1 and 2, FIGS. 11 and 12, and FIGS. 21 and 22, are particularly adapted for fastening to a front hoof, and where necessary, may be referred to herein as ‘front hoof’ horseshoes 1. However, it will be appreciated that these embodiments can also be used on a rear hoof.

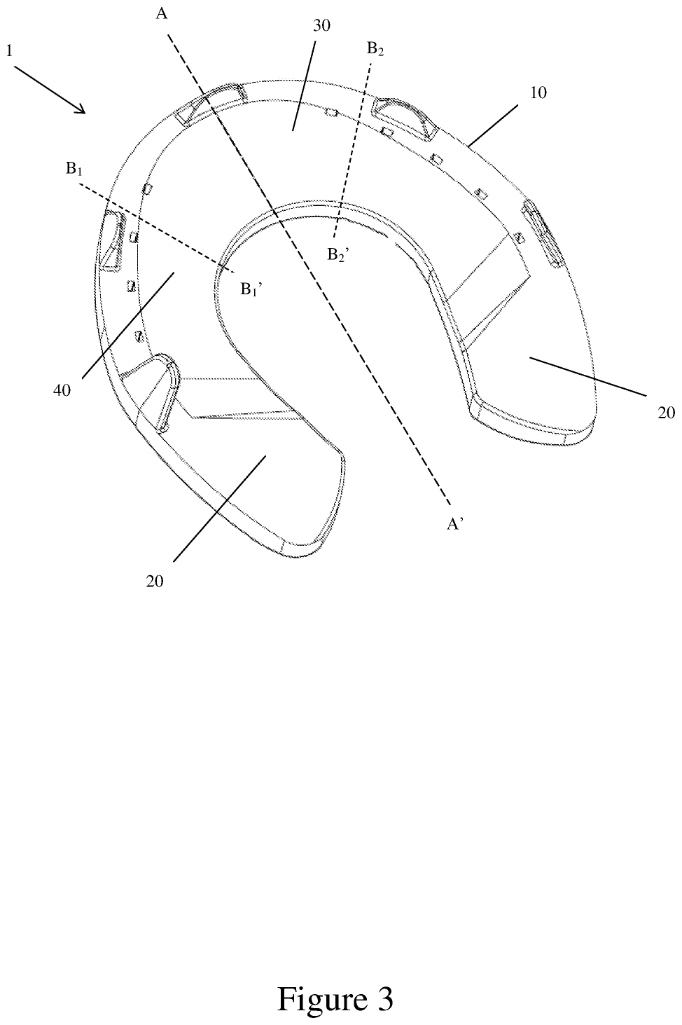

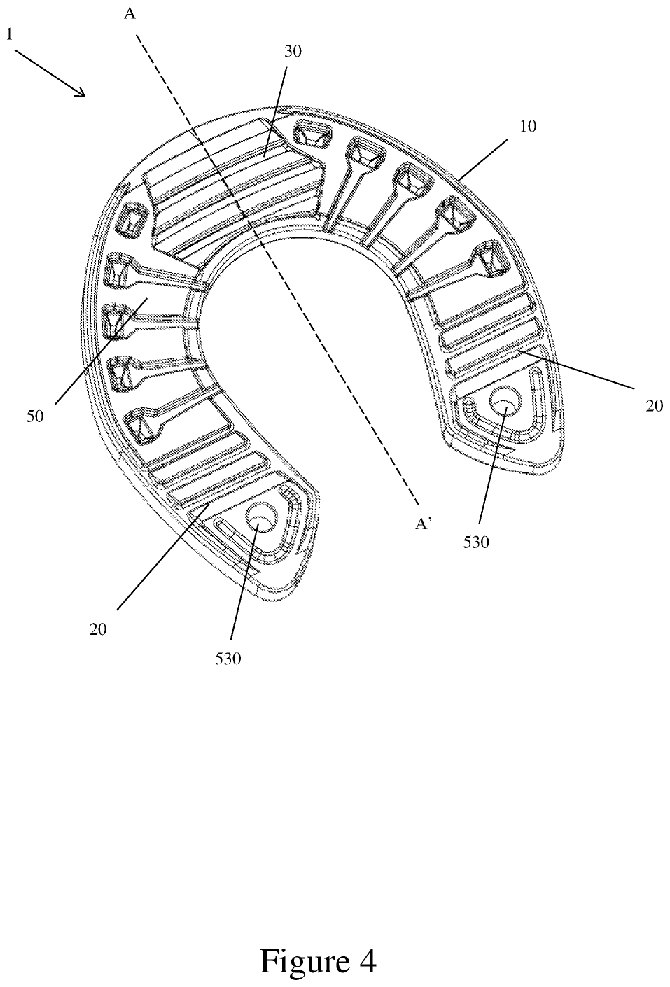

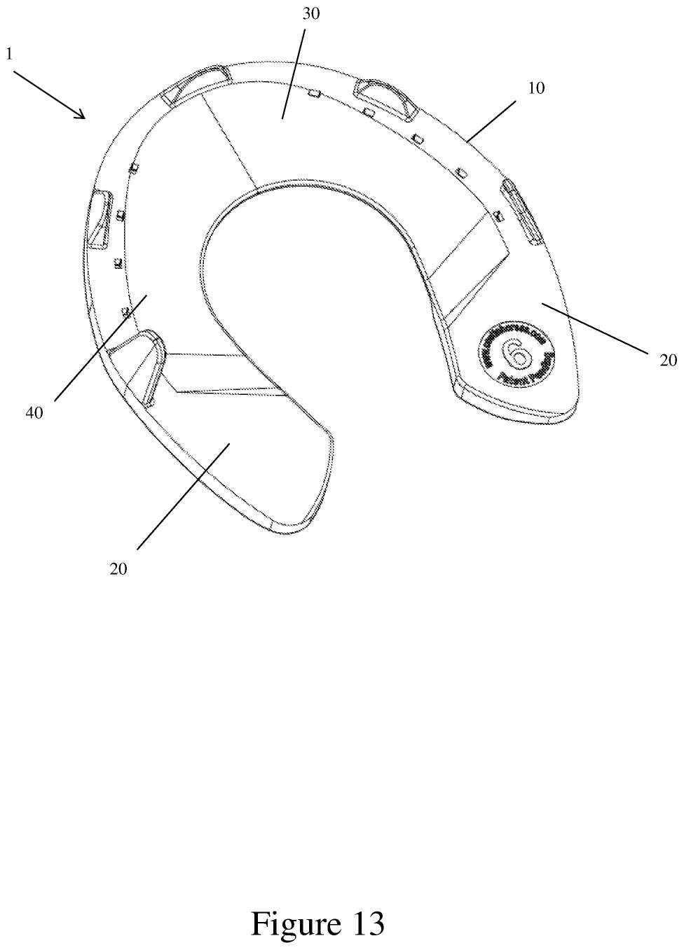

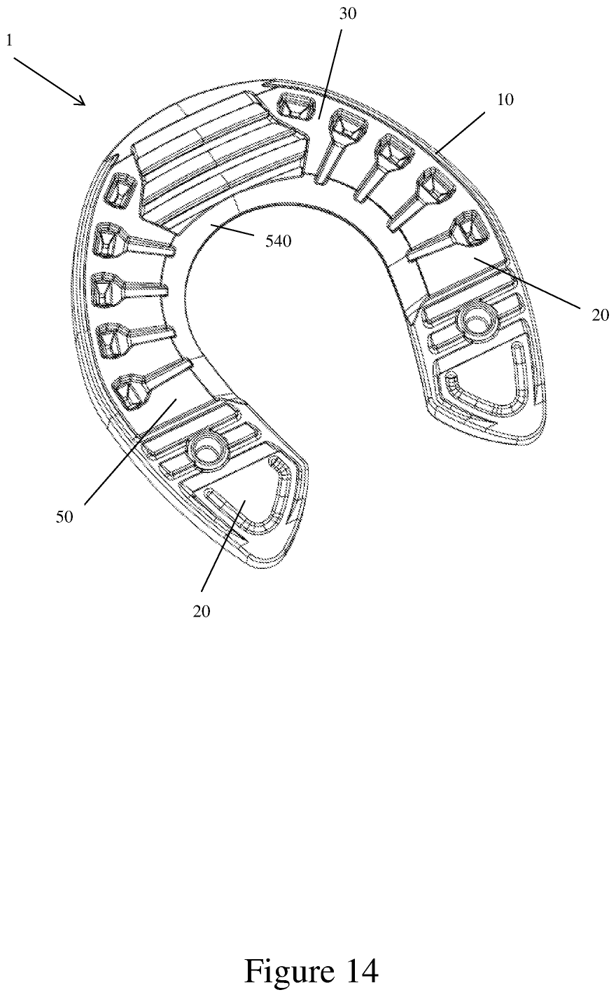

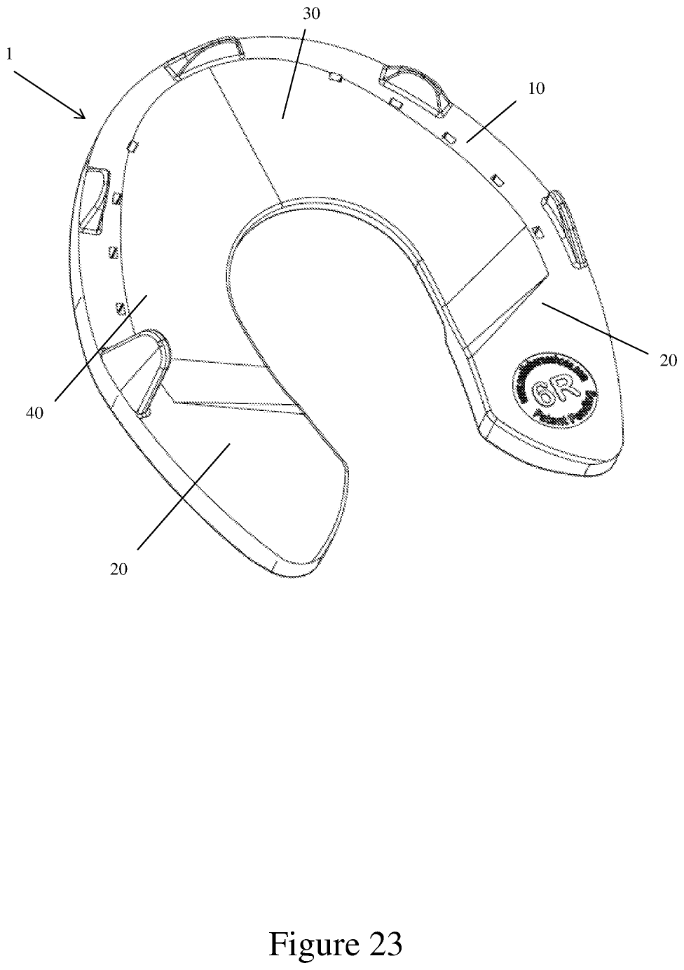

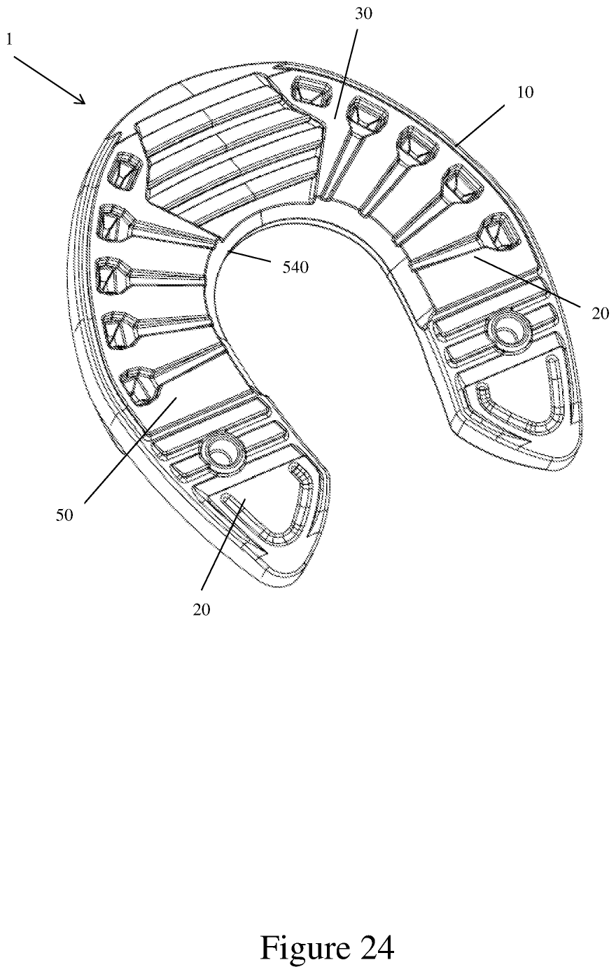

FIGS. 3 and 4 illustrate yet another embodiment of a horseshoe 1 according to the invention. FIGS. 13 and 14 illustrate still another embodiment of a horseshoe 1 according to the invention. FIGS. 23 and 24 illustrate still yet another embodiment of a horseshoe 1 according to the invention. The embodiments depicted in FIGS. 3 and 4, FIGS. 13 and 14, and FIGS. 23 and 24 are particularly adapted for fastening to a rear hoof, and where necessary, may be referred to herein as ‘rear hoof’ horseshoes 1. However, it will be appreciated that these embodiments can also be used on a front hoof.

It will be further understood that the embodiments of front hoof and rear hoof horseshoes 1 depicted in FIGS. 1-2 and 3-4; FIGS. 11-12 and 13-14; and FIGS. 21-22 and 23-24, respectively, may be referred to as ‘Design 1’ (front hoof horseshoes 1 depicted in FIGS. 1-2 and rear hoof horseshoes depicted in FIGS. 3-4); ‘Design 2’ (front hoof horseshoes depicted in FIGS. 11-12 and rear hoof horseshoes depicted in FIGS. 13-14); and ‘Design 3’ (front hoof horseshoes depicted in FIGS. 21-22 and rear hoof horseshoes depicted in FIGS. 23-24).

With reference to the above figures, preferred embodiments of horseshoe 1 of the invention will now be described.

Horseshoe 1 comprises body 10. Body 10 comprises legs 20 connected by bridge 30. Legs 20 comprise respective ends 21. Bridge 30 of horseshoe 1 is arcuate in shape and comprises a peak 32 at mid-point 31. A longitudinal axis A-A′ of horseshoe 1 passes through mid-point 31 of bridge 30, with horseshoe 1 substantially symmetrical about longitudinal axis A-A′.

Body 10 of horseshoe 1 comprises upper face 40 and lower face 50, which extend across legs 20 and bridge 30. Upper face 40 and lower face 50 comprise respective outer edges 41 and 51; respective inner edges 42 and 52; and respective edges 43 and 53 at respective ends 21 of legs 20.

Body 10 of horseshoe 1 has a maximum total length along the longitudinal axis. Furthermore, body 10 of horseshoe 1 has a maximum total width between points at the outer edges which are a maximum distance apart in a direction perpendicular to the longitudinal axis of the horseshoe. It will be appreciated that the size of body 10 of horseshoe 1, including the maximum total width and the maximum total length, can be varied as desired, e.g. to accommodate hoofs of varying sizes.

As pictured, body 10 of horseshoe 1 is of unitary construction, and formed from a material comprising polyurethane. Specifically, body 10 is formed from polyurethane, or a polyurethane-based polymer. As will be appreciated by the skilled person, polyurethane-based polymers are common in the art, and in addition to polyurethane typically comprise e.g. stabilizing agents and additives.

In certain embodiments, body 10 is formed from the polyurethane-based composition referred to herein as ‘Poly 1’, having properties set out in Table 1. In certain embodiments, body 10 is formed from the polyurethane-based composition referred to herein as ‘Poly 2’, having properties set out in Table 2. In certain embodiments, body 10 is formed from the polyurethane-based composition referred to herein as ‘Poly 3’, having properties set out in Table 3.

Although it is preferred that body 10 is formed from polyurethane or a polyurethane-based composition, it will be appreciated that other suitable flexible materials can be used. For example, in some alternative embodiments rubber based materials or lightweight and flexible metals or metal composites may be suitable.

In particularly preferred embodiments, body 10 of horseshoe 1 is formed from a material having physical parameters within specific ranges. Preferably, these physical parameters are selected from the group consisting of: hardness; density; tensile strength; elongation at break; stress at 20% elongation; stress at 100% elongation; stress at 300% elongation; modulus of elasticity; tear strength; abrasion loss; compression set at room temperature; compression set at 70° C.; notched impact strength; tensile set; taber abrasion; tensile strength; and stretching strength.

Suitable measures for assessing the above characteristics include American Society for Testing and Materials (ASTM) and/or Deutsches Institut für Normung (DIN) standards.

It will be appreciated that the material assessed to determine physical parameters or properties may be unprocessed or ‘raw’, or may be subject to processing e.g. injection moulding under specific conditions. It will be further appreciated that the particular physical properties of the material may vary somewhat depending on any processing that the material has been subject to prior to testing, and/or minor variation which can occur even when using standardised testing protocols.

Poly 1 material is marketed under the name ‘Wanthane® WHT-1172’ and, when raw, was found to have a durometer rating of 72 D. After processing to form body 10 of horseshoe 1, the material was found to have the properties set forth in Table 1. In some preferred embodiments, body 10 of horseshoe 1 has properties within ±25%, or preferably within ±10%, of one or more of the respective properties recited in Table 1.

Poly 2 material is marketed under the name ‘Elastollan® S 64 D’. Specifications of Elastollan® S 64 D, as provided by the manufacturer, are set forth in Table 2. In some preferred embodiments, body 10 of horseshoe 1 has properties within ±25%, or preferably within ±10%, of one or more of the respective properties recited in Table 2.

Poly 3 material is marketed under the name Elastollan® C 60 D. Specifications of for Elastollan® C 60 D, as provided by the manufacturer, are set forth in Table 3. In some preferred embodiments, body 10 of horseshoe 1 has physical parameters within ±25%, or preferably within ±10%, of one or more of the respective physical parameters recited in Table 3.

In preferred embodiments the body of horseshoe 1 is formed from a material having a hardness between 55 D and 85 D as measured using durometer scale either raw and/or after processing, including about: 56 D; 57 D; 58 D; 59 D; 60 D; 61 D; 62 D; 63 D; 64 D; 65 D; 66 D; 67 D; 68 D; and 69 D; 70 D; 71 D; 72 D; 73 D; 74 D; 75 D; 76 D; 77 D; 78 D; 79 D; 80 D; 81 D; 82 D; 83 D; and 84 D. More preferably, said hardness is between about 60 D and about 80 D. In some particularly preferred embodiments, said hardness is between about 67 D and about 77 D.

It will be appreciated that, in view of the unitary construction of horseshoe 1, legs 20 and bridge 30 extend continuously to form body 10. Unitary construction of horseshoe 1 is particularly preferred, as, inter alia, this is considered to contribute to the advantageous flexibility and/or mouldability of horseshoe 1. However, it will be appreciated that in alternative embodiments, body 10 may be formed from multiple components, for example legs 20 and bridge 30 may be formed from separate components.

It will also be appreciated that, in some embodiments, horseshoe 1 may be formed using ‘layers’ of material. By way of non-limiting example, a portion of body 10 including upper face 40 may be formed from polyurethane, and another portion of body 10 including lower face 50 may be formed from natural and/or synthetic rubber. Such an arrangement may offer enhanced durability of a horseshoe of the invention. In some such embodiments, lower face 50 may be formed from a rubber composition similar to that used in tires (e.g. car tires), and may optionally include patterns of tread.

As best seen in FIG. 1, bridge 30 of horseshoe 1 forms the portion of body 10 corresponding to points B₁ and B₂ on the outer edges, and points B₁′ and B₂′ on the inner edges, of upper face 40 and lower face 50.

It will be appreciated that corresponding points B₁ and B₁′, and B₂ and B₂′, are located a minimum distance apart across body 10 of horseshoe 1, as indicated by dashed lines. It will be further understood that, as used generally, corresponding points a minimum distance apart across body 10 correspond to the width of a section of the body horseshoe at a given position.

It will be appreciated that, in the embodiments described herein, bridge 30 represents a central portion of about 0.25 of the total volume of body 10. More generally, in preferred embodiments the bridge portion of horseshoes of the invention correspond to central portions of about 0.1 to about 0.5 of the volume of body 10, including about 0.15, about 0.20, about 0.25, about 0.30, about 0.35, about 0.40, and about 0.45.

As best seen in FIGS. 1 and 2, legs 20 extend inwardly towards longitudinal axis A-A′ of horseshoe 1. Ends 21 of legs 10 are oriented diagonally, with respective peaks 210 located distal from peak 32 of bridge 30.

As best seen in FIGS. 1 and 3, the width of horseshoe 1 is at a maximum (referred to herein as Bₘₐₓ) at the mid-point of bridge 30. Additionally, the width of horseshoe 1 is at a minimum at peaks 210 of ends 21.

In some embodiments, for example as depicted in FIGS. 1 and 2, the width of horseshoe 1 gradually decreases from Bₘₐₓ until respective points (L₁) of legs 20 near to ends 21, and then decreases more rapidly to form peaks 210 of ends 21.

In some embodiments, for example as depicted in FIGS. 3 and 4, the width of horseshoe 1 fluctuates between Bₘₐₓ until respective points Li, prior to rapid decrease to form peaks 210.

The abovementioned differences in widths at different locations of body 10 of horseshoe 1 in the embodiment depicted in FIGS. 1 and 2 compared to the embodiment depicted in FIGS. 3 and 4 are adapted to suit use of the respective horseshoes as ‘front hoof’ and ‘rear hoof’ horseshoes, as hereinabove described.

As will be understood by the skilled person, generally, the front hoofs bear the majority of the weight of a horse when standing and moving. Furthermore, the rear hoofs have an important role in ‘pushing’ when commencing and during movement.

Accordingly, increased width of front horseshoe 1 as compared to rear horseshoe 1 at positions of the bridge flanking Bₘₐₓ is adapted for optimal flexing and moulding of front horseshoe 1 under relatively greater load. Furthermore, decreased width of rear horseshoe 1 as compared to front horseshoe 1 at said positions is adapted for optimal flexing and moulding of rear horseshoe 1 under relatively lesser load, and in consideration of the important ‘pushing’ role of the rear hoofs.

It will also be appreciated, with reference to FIGS. 1 and 3, that an arcuate shape of inner edge 42 is substantially the same for both the ‘front hoof’ and ‘rear hoof’ horseshoes 1, with the differences in widths at different locations of body 10 resulting from differences in shapes of outer edge 41. The use of the same shape of inner edge 42 is advantageous to allow for the same attachments to be used for a corresponding front hoof and rear hoof horseshoe 1.

As pictured, the ratio of the width at Li compared to the width at Bₘₐₓ is approximately 0.70-0.90. More generally, in horseshoes of the invention, without limitation thereto, the width at a point corresponding to L₁ as compared to the width at Bₘₐₓ is preferably between 0.65 to less than 1, including about: 0.70, 0.75, 0.80, 0.85, 0.90, and 0.95.

It will be appreciated that, in some alternative embodiments, legs 20 do not comprise peaks 210. In these embodiments, the points corresponding to L₁ may be at ends of legs 20.

It will be further appreciated that, in the embodiments herein described, the average width of each of legs 20 is less than the average width of bridge 30. Generally, without limitation thereto, it is preferred that the average width of each of legs 20 as compared to the average width of bridge 30 is between about 0.65 to less than 1, including about: 0.70, 0.75, 0.80, 0.85, 0.90, and 0.95.

In the embodiments herein described, the ratio of the average width of bridge 30 to the maximum length of the body 10 is about 0.25 to about 0.35. Generally, although without limitation thereto, it is preferred that said ratio is between about 0.2 to about 0.4, including about 0.2, about 0.25, about 0.3, and about 0.35.

In particularly preferred embodiments of ‘front hoof’ horseshoes such as depicted in FIGS. 1-2; 11-12; and 21-22, said ratio is greater than about 0.25, and preferably greater than about 0.26; 0.27; 0.28; or 0.29.

In particularly preferred embodiments of ‘rear hoof’ horseshoes such as depicted in FIGS. 3-4; 13-14; and 23-24, said ratio is greater than about 0.30, and preferably greater than about 0.31; 0.32; 0.33; or 0.34.

It is considered that said ratios are particularly desirable in regard to flex, resilience, and/or durability of the front hoof and rear hoof horseshoes, respectively.

Additionally, in the embodiments herein described, the ratio of the average width of legs 20 to the maximum width of body 10 is about 0.25. Generally, although without limitation thereto, it is preferred that said ratio is between about 0.15 to about 0.35, including about 0.2, about 0.25, and about 0.3.

In some preferred embodiments, the average thickness of body 10 (referred to herein as T_{A}), i.e. the average distance between upper face 40 and lower face 50, is less than about half of the maximum width of the bridge (Bₘₐₓ). Generally, without limitation thereto, said ratio may be between about 0.05 to about 0.4, including about: 0.1, 0.15, 0.2, 0.25, 0.3, and 0.35.

In particularly preferred embodiments, said ratio is greater than about 0.19, preferably about 0.21. It is considered that embodiments with a ratio of greater than about 0.19 or preferably about 0.21 of T_{A} to Bₘₐₓ are particularly desirable in regard to flex, resilience, and/or durability of the shoe. This is considered to be particularly the case for ‘rear hoof’ horseshoes, although without limitation thereto.

Similarly, in some preferred embodiments, the maximum thickness of body 10 (referred to herein as Tₘₐₓ) i.e. the maximum distance between upper face 40 and lower face 50, is less than about half of the maximum width of the bridge (Bₘₐₓ). Generally, without limitation thereto, said ratio is between about 0.1 to about 0.45, including about: 0.15, 0.2, 0.25, 0.30, 0.35, 0.4, and 0.45.

In particularly preferred embodiments, said ratio is greater than about 0.23, preferably about 0.25. It is considered that embodiments with a ratio of greater than about 0.23 or preferably about 0.25 of Tₘₐₓ to Bₘₐₓ are particularly desirable in regard to flex, resilience, and/or durability of the shoe. This is considered to be particularly the case for ‘rear hoof’ horseshoes, although without limitation thereto.

In some preferred embodiments of horseshoe 1, Tₘₐₓ is between about 8 and about 14 mm, although without limitation thereto. As depicted in FIGS. 1-4 and 21-24 Tₘₐₓ is about 12 mm. As depicted in FIGS. 11-14 Tₘₐₓ is about 10 mm. It will be appreciated, however, that the optimum thickness may vary depending on the overall size of horseshoe 1.

In some embodiments, the thickness of body 10 may vary at different regions of said body. In such embodiments, this variation in thickness may create inclination, slope, and/or elevation of upper face 40 and/or lower face 50, when lower face 50 is engaged with the ground. In certain embodiments, the arrangement of variation in thickness may be similar as hereinbelow described in regard to attachment body 101.

As best seen in FIGS. 1 and 2, body 10 comprises channels 450 linking upper face 40 and lower face 50. Specifically, body 10 comprises 5 channels arranged proximal to the outer edges of body 10 spaced from the bridge along each of the legs, on either side of longitudinal axis A-A′. As pictured, channels 450 are substantially rectangular in cross sectional shape, However, it will be appreciated that the shape of channels 450 can be varied as desired.

As best seen in FIGS. 1 and 3, a portion of the surface of upper face 40 of horseshoe 1 is inclined downwardly towards inner edge 42. As indicated by the detail on upper face 40 in FIGS. 1 and 3, the inclination (or ‘chamfer’) starts from nearer to outer edge 41 than inner edge 42 and ends at inner edge 42. Furthermore, the inclined portion extends across bridge 30 and part way along legs 20. It will be appreciated however that the particular arrangement of the inclined portion, for example the proximity to outer edge 41 at which the inclination starts, and/or the degree to which the inclined portion extends across the bridge and/or the legs, can be varied.

The presence of an inclination as described above on upper face 40 may be advantageous to relieve pressure on the sole of a foot. Additionally, the inclination may assist in accommodating shock absorbing material that can be used with horseshoe 1, as hereinbelow described.

In alternative embodiments the surface of upper face 40 does not comprise an inclination as set forth above, and instead may be substantially flat.

Upper face 40 comprises a plurality of catches or ‘clips’ 410 extending from outer edge 41. Specifically, upper face 40 comprises a clip 410A extending from outer edge 41 at mid-point 31; a pair of clips 410B extending from the outer edge 41 each at each of legs 20 adjacent to bridge 30; and a pair of clips 410C extending from outer edge 41 at each of legs 20 towards ends 21.

Clips 410A, 410B, and 410C are inclined inwardly towards inner edge 42 of upper face 40.

As pictured in FIGS. 1 and 3, the height of clip 410A and clips 4106 is the same, i.e. clips 410A and 4106 extend from upper face 40 to the same degree. Furthermore, the height of clips 410C is greater than of clips 410A and 410B. This arrangement of clip heights is considered beneficial for the invention; specifically, the increased height of clips 410C may assist with stabilizing the horseshoe against the back of a hoof. However, it will be appreciated that this arrangement of heights of the clips is not essential and may be varied as desired. It will be further appreciated that, in preferred embodiments wherein horseshoe 1 is constructed from a plastic or polyurethane material, one or more of clips 410A-410C can be easily removed, e.g. by cutting, if desired.

As best seen in FIGS. 2 and 4, lower face 50 comprises protrusions or ‘tread’ 510. Protrusions 510 comprise inclined faces 511, and substantially upright walls 512.

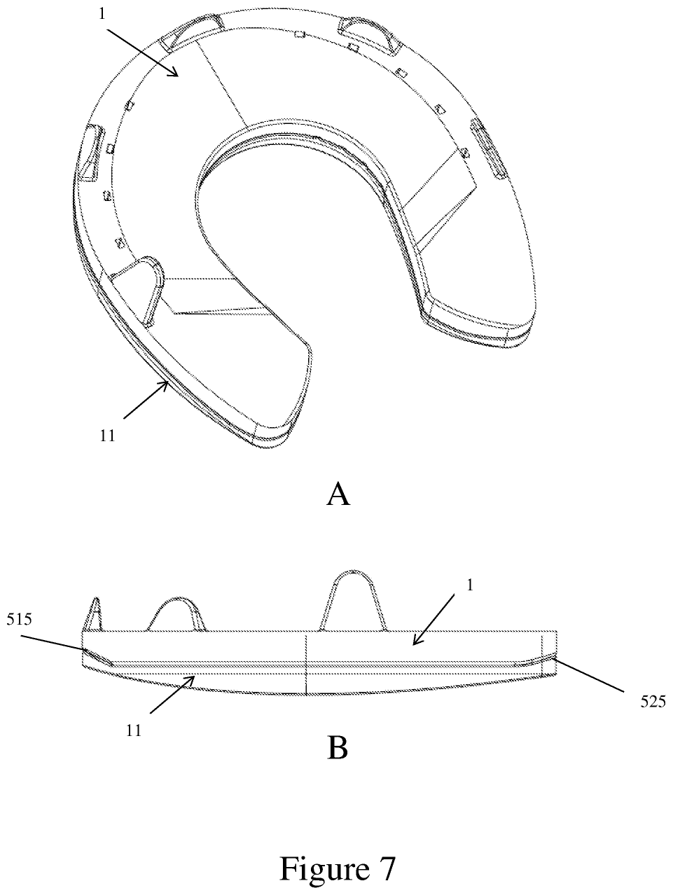

As best seen in FIG. 7, a portion 515 of lower face 50 which flanks mid-point 31 of bridge 30 is inclined in a first direction. Additionally, portions 525 of lower face 50 at ends 21 are inclined in a direction opposed to the first direction.

Furthermore, as best seen in FIG. 2, lower face 50 comprises channel indentations 520, framing channels 450. As depicted, channel indentations 520 comprise a portion 521 that is trapezoidal in three dimensional shape, and extends towards channel 450. Channel indentations 520 also comprise a portion extending inwardly towards inner edge 52 of lower face 50.

The particular shape and depth of channel indentations 520 has been optimized in consideration of the strength and durability of body 10. With reference to the comparison of FIGS. 22 and 24; FIGS. 12 and 14; and FIGS. 2 and 4, it will be appreciated the depth of the channel indentations, relative to the thickness of the shoe, is greater in the Design 2 and Design 3 embodiments than in the Design 1 embodiments. It is considered that the arrangement as per FIGS. 22 and 24 has particular advantages with respect to strength and/or durability, under at least certain conditions.

Lower face 50 of horseshoe 1 also comprises attachment indentations 530. As depicted, attachment indentations 530 comprise substantially circular openings and extend approximately halfway into body 10. However, other shapes suitable for receiving a corresponding protrusion of an attachment can also be used.

Additionally, in some embodiments, one or more attachment indentations 530 may extend between lower face 50 and upper face 40, taking the form of channels.

As best seen in FIGS. 12 and 14 and FIGS. 22 and 24, Design 2 and Design 3 embodiments of horseshoe 1 comprise a portion of lower face 50 that is inclined upwardly towards the inner edge. This portion is in the form of chamfer 540 extending along bridge 30 and part way along each of the respective legs 20.

The presence of chamfer 540 reduces the surface area of contact on the ground which can provide greater grip to horseshoe 1. Furthermore, the presence of chamfer 540 decreases the total weight of horseshoe 1. Both of these effects may be beneficial in at least certain circumstances, e.g. for horse racing.

With reference to FIGS. 12 and 14, and FIGS. 22 and 24, it will be appreciated that, in embodiments comprising chamfer 540, inner edge 52 of lower face 50 is spaced apart from inner edge 42 of upper face 40 at distance that can be measured with respect to the width of upper face 42.

It will be understood that the average distance between inner edge 52 of lower face 50 and inner edge 42 of upper face 40 as measured with respect to the width of upper face 42, can be represented as a ratio to Bₘₐₓ (the maximum width of the bridge, as hereinabove described). As used herein, this ratio may be referred as a Chamfer Width (C_{w}) ratio. As best seen in FIGS. 12 and 14, in this embodiment of horseshoe 1, the C_{w} ratio is about 0.11. As best seen in FIGS. 22 and 24, in this embodiment of horseshoe 1, the C_{w} ratio is about 0.08.

In certain circumstances, it is preferred that the C_{w} ratio is between about 0.05 and about 0.1, or preferably about 0.08. It is considered that embodiments of horseshoe 1 with a C_{w} ratio of between about 0.05 and about 0.1, or preferably about 0.08, can be particularly desirable in regard to flex, resilience, and/or durability of the shoe. This is considered to be particularly the case for ‘rear hoof’ horseshoes, although without limitation thereto.

In use, horseshoe 1 can be fastened to a hoof using any suitable fastener. Suitable fasteners include mechanical fasteners including nails and screws, and chemical fasteners or adhesives, such as glues.

In preferred embodiments, horseshoe 1 is fastened to a lower or ground engaging surface of a hoof using fasteners adapted to pass through channels 450, with ends of the fasteners restrained against channel indentations 520.

The presence of channels 450 is advantageous as it may allow for easier or more efficient fastening of the horseshoe. Additionally, the portion 521 of channel indentation 520 surrounding the openings of channels 450 on the lower surface 50 may facilitate alignment of a fastener for fastening through channels 450. In this respect, it will be appreciated that channels 450, and channel indentations 520, can act as ‘guides’ for fastening, which may be particularly helpful for more inexperienced users.

However, it will also be appreciated that, in alternative embodiments, horseshoe 1 may lack channels 450. In these embodiments, where a mechanical fastener is used for attachment, the fastener can be forced through body 10 into a hoof.

In some embodiments, in use, a mechanical fastener is forced through body 10 into a hoof in a region of channel indentation 520. The extension of the portion of channel indentation 520 towards the inner edge 52 of lower face 50 may be advantageous for such embodiments. In this regard, it will be appreciated that in certain circumstances, such as when fitting horseshoe 1 to a damaged and/or misshapen hoof, horseshoe 1 may be ‘trimmed’, wherein one or more regions at outer edge 51 are removed, e.g. to better fit the damaged and/or misshapen hoof. In such embodiments, the mechanical fastener may advantageously be placed within a region of channel indentation 520 that has not been removed by trimming.

In preferred embodiments wherein fasteners are used to attach horseshoe 1 to a hoof, the fasteners used are adapted such that, upon fastening of horseshoe 1 through channels 450 and/or within channel indentations 520, a first end of the fastener does not protrude from the upper surface of the hoof.

It will be appreciated that the use of fasteners, such as nails, which protrude from the upper surface of the hoof, and are subsequently trimmed, as in the fastening of conventional horseshoes, can create substantial damage to the hoof. Advantageously, due to the relatively light weight of preferred embodiments of horseshoe 1, suitably strong and stable fastening can be achieved using fasteners which do not protrude from the upper surface of the hoof. For the same reason, at least in some circumstances, use of a chemical adhesive may be appropriate to achieve suitably strong and stable fastening of horseshoe 1.

In preferred embodiments wherein fasteners are used to attach horseshoe 1 to a hoof, the fasteners are preferably adapted such that a second end of the fastener sits within channel indentation 520. In addition to ensuring that the second end of the fastener does not protrude above lower face 50 of the horseshoe, placement of a second end of the fastener within channel indentation 520 can assist in preventing unfastening of the horseshoe, e.g. by complete passing of the fastener through channel 450.

In use, clips 410 engage with the upper surface of a hoof. Engagement of clips 410 with the upper surface of the hoof is particularly advantageous for holding or positioning horseshoe 1 in place during fastening.

It will be appreciated that horseshoe 1 can be slid onto the lower surface of a hoof, wherein clips 410 hold or position horseshoe 1 against the upper surface of the hoof. In this respect, in the embodiments described herein, the placement of clips 410C towards the respective ends 21 of legs 20 is advantageous, since sliding of horseshoe 1 onto a hoof will generally require passing clips 410C over the broadest point of the hoof, which is facilitated by the flexibility of body 10 and clips 410. When so positioned, clips 410 stably engage the hoof, facilitating fastening.

It will be appreciated that use of clips 410 for holding and positioning horseshoe 1 may be particularly advantageous to allow fastening of horseshoe 1 by more inexperience users.

In use, in some preferred embodiments, a front hoof horseshoe 1 is attached to each of the front hoofs, and a rear hoof horseshoe 1 is attached to each of the rear hoofs.

In use, when suitably fastened to a hoof, horseshoe 1 flexes with the natural flexing and widening of the hoof when engaged with the ground. Additionally, horseshoe 1 can mould to the shape of the hoof.

Flexing and moulding of horseshoe 1 is particularly advantageous, as this allows natural shock absorption of the hoof to occur when shoed. This can prevent injury to the hoof, foot, and/or leg.

Furthermore, horseshoe 1 is adapted to prevent strain on the front end of a hoof as typically occurs using conventional horseshoes. As will be appreciated by the skilled person, due to the relative inflexibility of conventional horseshoes, fastening of the shoe is generally performed to the front end of a hoof only. As such, pivoting of the inflexible shoes against the front end of the hoof typically causes strain and consequent damage to the hoof.

In contrast, the flexibility and mouldability of horseshoe 1 as described herein can prevent or at least substantially reduce strain to the front end of the hoof. Furthermore, horseshoe 1 is adapted for attachment along the lower surface of the hoof, rather than at the front portion of the hoof only. For example, when fasteners are placed into channels 450 for fastening of horseshoe 1 to a hoof, horseshoe 1 will typically be fastened along opposite sides of the lower surface of the hoof.

As hereinabove described, the embodiments of horseshoe 1 illustrated in FIGS. 1-4, FIGS. 11-14, and FIGS. 21-24, and preferred other embodiments of the horseshoe of the invention, have particular parameters in relation to the width of the body of the horseshoe at bridge 30 as compared to each of the legs 10. These parameters are considered to be particularly advantageous for flexibility of the horseshoe when attached to a hoof under load, and for moulding of the horseshoe to a hoof.

Furthermore, as hereinabove described, the embodiments of horseshoes 1 illustrated in FIGS. 1-4, FIGS. 11-14, and FIGS. 21-24, and preferred other embodiments of the horseshoe of the invention, have particular parameters in relation to the thickness of horseshoe. These parameters are considered to be particularly advantageous for flexibility of the horseshoe when attached to a hoof under load, and for moulding of the horseshoe to a hoof.

Additionally, as hereinabove described, the unitary construction of horseshoes 1 illustrated in FIGS. 1-4, FIGS. 11-14, and FIGS. 21-24 is considered particularly advantageous for flexibility of the horseshoe when attached to a hoof under load, and for moulding of the horseshoe to a hoof.

Generally, the parameters of horseshoe 1 are optimised for flexibility and mouldability. Particularly when constructed using preferred materials as described herein, observations in a substantial number of horses, e.g. as set forth in Table 4, indicate that horseshoe 1 offers advantageous comfort and ‘feel’. It will be readily appreciated that this may have advantageous effects on a horse's gait, temperament and/or behaviour, as exemplified in Table 4.

Observations have also been made indicating that horseshoe 1 can assist with reducing or eliminating lameness, such as resulting from laminitis. These observations are consistent with the advantageous flexibility and/or moudability of horseshoe 1, with reference, for example, to Biomechanics of lameness in horses (1977), James Rooney (incorporated herein by reference).

In use, protrusions 510 of lower face 50 of horseshoe 1 provide traction of the hoof against the ground. While the particular structure of protrusions 510 as illustrated in FIGS. 2 and 4, FIGS. 12 and 14, and FIGS. 22 and 24 are considered desirable for a horseshoe of the invention, it will be appreciated that other arrangements of protrusions can also be used, including, for example, protrusions in the form of ‘caulkins’ of conventional horseshoes.

Furthermore, the particular pattern or arrangement of protrusions and/or indentations, or ‘tread’ on lower face 50 can be adapted to suit particular purposes. It will be also be appreciated that, in some alternative embodiments, no substantial protrusions or indentations for providing traction may be provided, and lower face 50 may instead by predominantly flat.

In use, the inclined portions 515 and 525 of lower face 50 facilitate pivoting of the hoof against the ground, facilitating natural movement of the hoof. The inclusion of inclined portions 515 and 525 is considered advantageous as it may further facilitate natural shock absorption by the hoof, and this and/or facilitation of natural movement may reduce stress on the hoof and/or leg.

In some alternative embodiments, lower face 50 may be arcuate in longitudinal section, similar as hereinbelow described in relation to horseshoe attachment 11 with reference to FIG. 7.

In use, attachment indentations 530 are adapted to receive corresponding protrusions from a horseshoe attachment. It will be appreciated that the presence of attachment indentations 530 can assist with stable connection of a suitably adapted horseshoe attachment to horseshoe 1.

In use, an additional shock absorbing material may be applied with a horseshoe of the invention. Preferably, the shock absorbing material is placed between upper face 40 of the horseshoe and a hoof and/or foot to which the horseshoe is applied.

In one preferred embodiment, the shock absorbing material is a ‘flowable’ material which can be dispensed in liquid or semi-liquid state, prior to solid setting. Suitably, the shock absorbing material will be elastic or resiliently deformable, and serve to provide a ‘cushioning’ effect on the hoof. Particularly preferred materials include ‘hoof repair’ epoxy resin products, such as ‘Equi-thane Hoof Repair™’, or ‘Equilox Hoof Repair™’ or similar.

As hereinabove described, the presence of an inclination or chamfer in embodiments of horseshoe 1 of the invention such as depicted in FIGS. 1 and 3; 11 and 13; and 21 and 23, can be advantageous to accommodate shock absorbing material between upper face 40 and a hoof and/or foot. However, it will be appreciated that the presence of an inclination or chamfer is not essential for use of a shock absorbing material as hereinabove described, and such a material can also be placed onto a substantially flat upper face 40 of certain alternative embodiments of horseshoe 1, for example.

A shock absorbing material can be applied as hereinabove described using any suitable method. In some preferred embodiments, the shock absorbing material is dispensed or ‘squirted’ through an indentation 530 located in lower face 50 at bridge 330.

In preferred such embodiments wherein indentation 530 extends approximately halfway into body 10, indentation 530 is first extended (e.g. drilled) through body 10 (i.e. from lower face 50 to upper face 40). Alternatively, it will be appreciated that in embodiments of horseshoe 1 wherein indentation 530 is in the form of a channel between lower face 50 and upper face 40, the shock absorbing material can be dispensed through indentation 530 without the need for prior extension.

The use of an additional shock absorbing material with a horseshoe of the invention may be advantageous to further protect a hoof and/or foot from forces applied during movement. This may be particularly desirable to treat conditions or injury such as lameness.

In use, in embodiments of horseshoe 1 which comprise chamfer 540 on lower face 50, chamfer 540 can facilitate the escape of dirt and other material from the underside of a hoof. It is considered that this can assist with keeping the hoof clean, and can also assist with prevention of sole bruising.

Various benefits of the use of horseshoe 1 as described herein have been observed. Certain observed such benefits are set forth in Table 4.

With reference to Table 4, it will be appreciated that horseshoe 1 has been observed to treat and/or prevent certain conditions of a hooved animal, more specifically a horse, when used in place of conventional horseshoes. These conditions include conditions of the leg and/or hoof, including shin soreness and/or shin splints; knee soreness and/or swelling; heel soreness; front leg soreness; and ‘shelly hoof’ including thin and/or cracked hoof walls. These conditions further include conditions of temperament and/or behaviour including irritability; and conditions of abnormal or undesirable gait such as lameness; short strides; and/or ‘jarring up’.

With reference to Table 4, it will be further appreciated that horseshoe 1 has been observed to improve performance of racing animals, more specifically racehorses, when used in place of conventional horseshoes. The performance that has been improved includes flat racing such as thoroughbred racing, and harness racing (or ‘trotting’). Improvements have been observed both overall, i.e. on all track conditions including hard and/or dry tracks and soft and/or wet tracks, and particularly on soft and/or wet tracks.

It will also be appreciated in view of Table 4 that horseshoe 1 has been observed to improve performance of eventing animals, more specifically eventing horses. As will be appreciated by the skilled person, eventing may be performed in some case using unshod horses, particularly where the horse does not tolerate shoeing with conventional steel and/or aluminium shoes. It has been observed that the performance of an eventing horse that did not tolerate shoeing with conventional shoes was greatly improved when shoed using horseshoe 1.

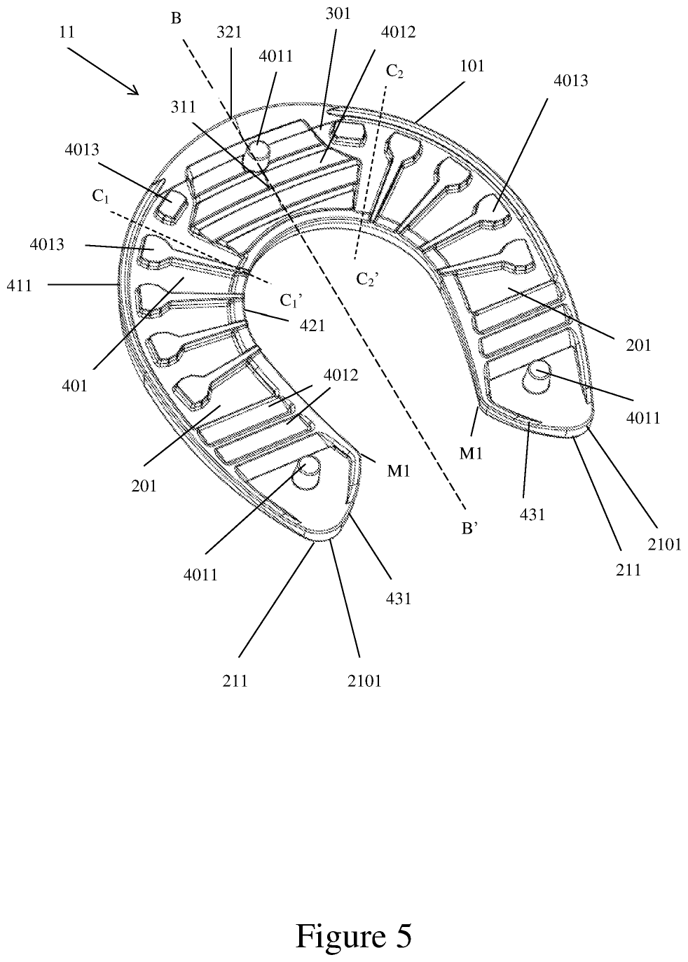

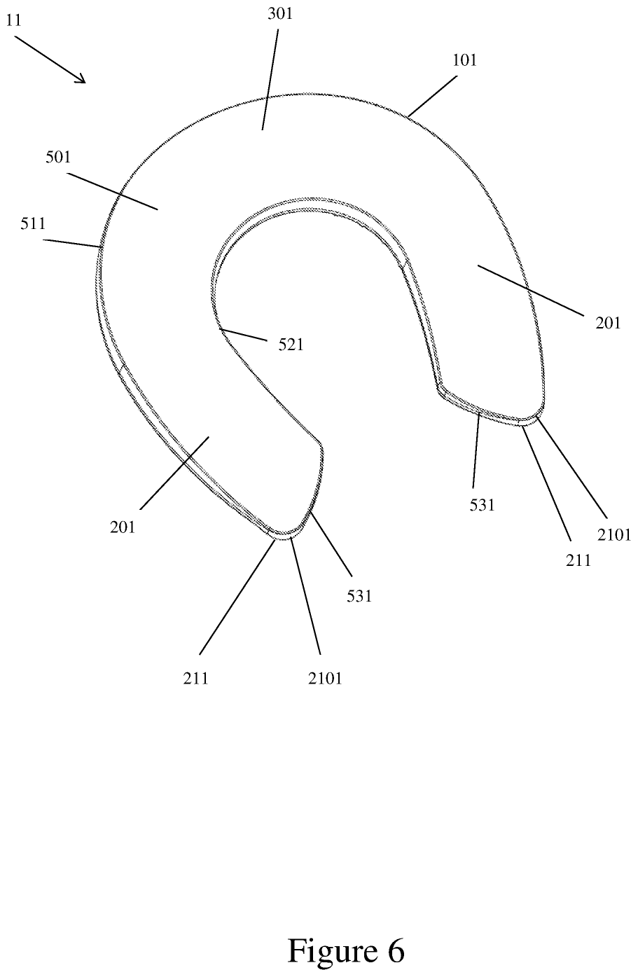

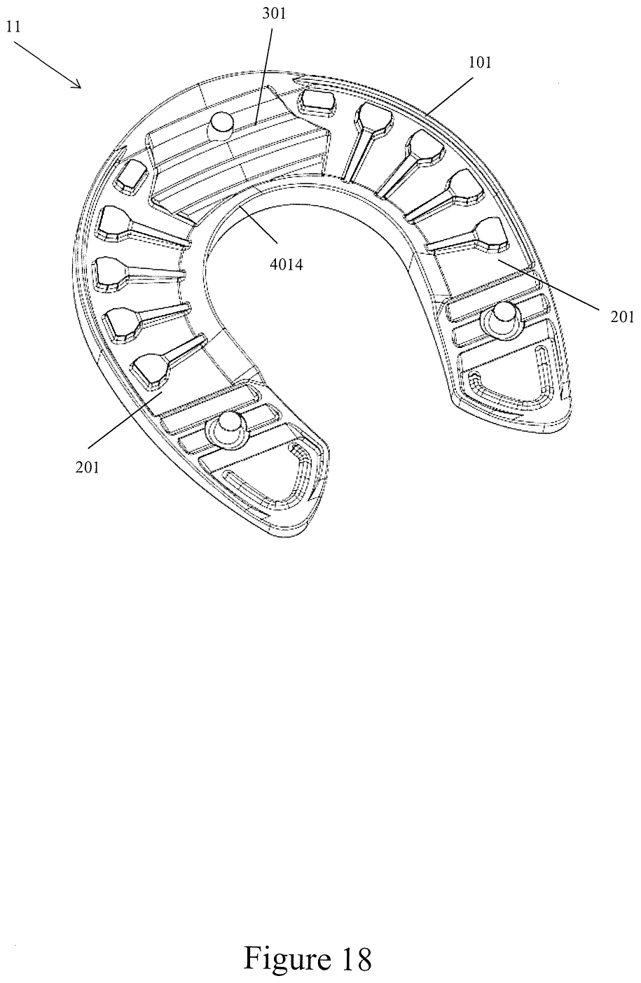

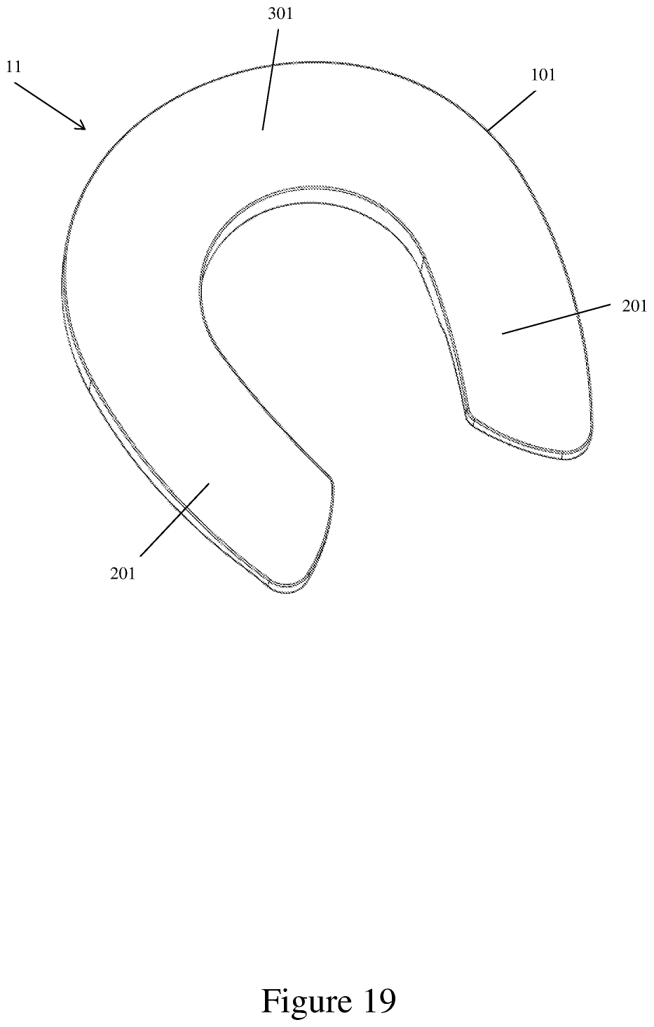

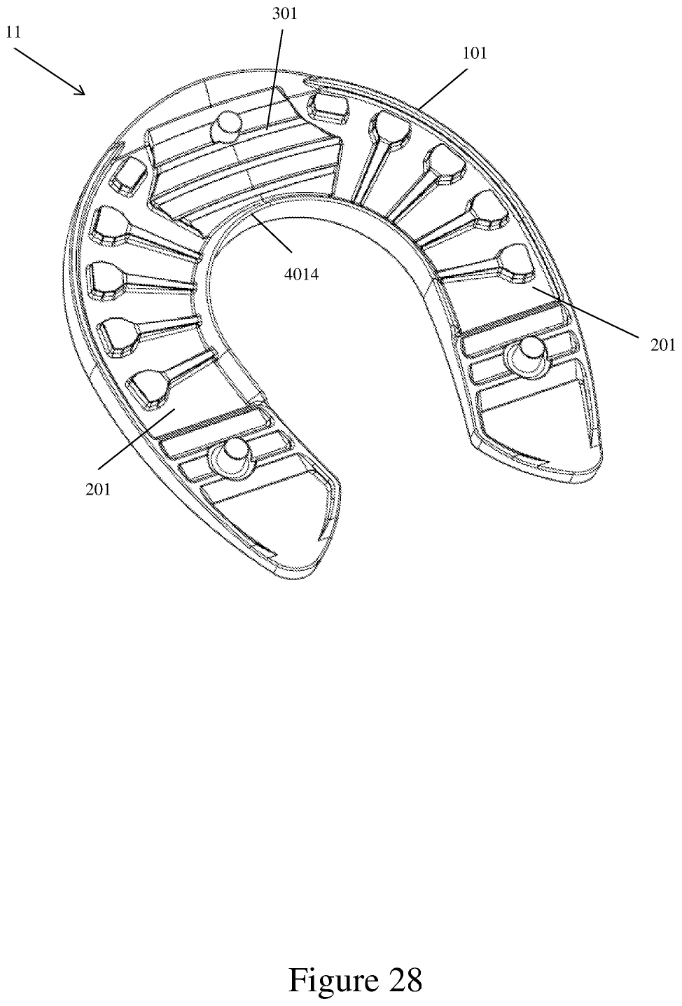

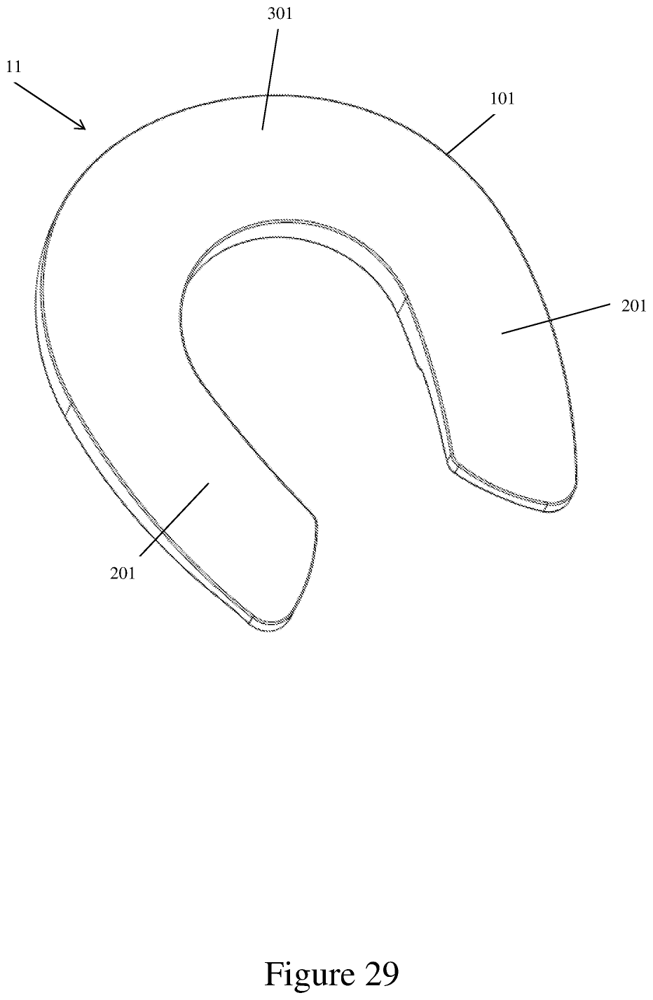

Turning now to FIGS. 5 and 6; FIGS. 18 and 19; and FIGS. 28 and 29, embodiments of horseshoe attachment 11 according to the invention will now be described. These embodiment of attachment 11 are particularly adapted for connection to front hoof horseshoe 1 depicted in FIGS. 1 and 2; FIGS. 11 and 12; and FIGS. 21 and 22, respectively, the respective attachment having an attachment body 101 shaped of substantially the same shape as front hoof horseshoe 1.

However, it will be appreciated that these embodiments of attachment 11 may also potentially be used for connection to the rear hoof horseshoe 1 depicted in FIGS. 3 and 4; FIGS. 13 and 14; and FIGS. 23 and 24, respectively. In this respect, as hereinabove described, arcuate shapes of inner edge 42 of front hoof and rear hoof horseshoe 1 are substantially the same, which can be advantageous for use of the same embodiment of attachment 11 with corresponding front hoof and rear hoof horseshoes 1.

It will also be readily appreciated that similar embodiments of attachment 11 can have an attachment body of substantially the same shape as rear hoof horseshoe 1 depicted in FIGS. 3 and 4; FIGS. 13 and 14; and FIGS. 23 and 24, respectively, and thereby be particularly adapted for connection with rear hoof horseshoe 1.

It will be further appreciated that the embodiments of attachment 11 depicted in FIGS. 5 and 6 are particularly adapted for connection with Design 1 horseshoes 1; the embodiment of attachment 11 depicted in FIGS. 18 and 19 are particularly adapted for connection with Design 2 horseshoes 1; and the embodiment of attachment 11 depicted in FIGS. 28 and 29 are particularly adapted for connection with Design 3 horseshoes 1.

It will nevertheless be understood that, in alternative embodiments, attachment 11 may have a substantially different shape from horseshoe 1 to which it may be attached. By way of non-limiting example, attachment 11 may have outer and/or inner edges which extend beyond corresponding outer and/or inner edges of horseshoe 1.

As best seen in FIG. 5, attachment body 101 comprises attachment legs 201 connected by attachment bridge 301. Attachment legs 201 comprise respective ends 211. Attachment bridge 301 is arcuate in shape and comprises a peak 321 at mid-point 311. A longitudinal axis B-B′ of attachment 11 passes through mid-point 311 of bridge 301, with attachment 11 substantially symmetrical about longitudinal axis B-B′.

As best seen in FIGS. 5 and 6, attachment body 101 comprises attachment upper face 401 and attachment lower face 501, which extend across attachment legs 201 and attachment bridge 301. Attachment upper face 401 and attachment lower face 501 comprise respective outer edges 411 and 511; respective inner edges 421 and 521; and respective edges 431 and 531 at respective ends 211 of attachment legs 101.

Body 101 of attachment 11 has a maximum total length along the longitudinal axis. Furthermore, attachment body 101 has a maximum total width between points at the outer edges which are a maximum distance apart in a direction perpendicular to the longitudinal axis of the attachment.

As pictured, body 101 of attachment 11 is of unitary construction, and formed from a polyurethane-based material. Specifically, body 101 is formed from polyurethane polymer. Polyurethane or polyurethane-based polymer is preferred according to the invention. It will be appreciated, however, that other suitable materials can be used. For example, in some alternative embodiments rubber based materials or lightweight and flexible metals or metal composites may be suitable.

In particularly preferred embodiments, body 101 of attachment 11 is formed from a material having physical parameters within specific ranges. Preferably, these physical parameters are selected from the group consisting of: hardness; density; tensile strength; elongation at break; stress at 20% elongation; stress at 100% elongation; stress at 300% elongation; modulus of elasticity; tear strength; abrasion loss; compression set at room temperature; compression set at 70° C.; notched impact strength tensile set; taber abrasion; tensile strength; and stretching strength.

In certain embodiments, body 101 is formed from the polyurethane-based composition referred to herein as ‘Poly 1’, having properties set out in Table 1. In some preferred embodiments, body 101 of horseshoe 11 has properties within ±25%, or preferably within ±10%, of one or more of the respective properties recited in Table 1.

In certain embodiments, body 101 is formed from the polyurethane-based composition referred to herein as ‘Poly 2’, having properties set out in Table 2. In some preferred embodiments, body 101 of horseshoe 11 has properties within ±25%, or preferably within ±10%, of one or more of the respective properties recited in Table 2.

In certain embodiments, body 101 is formed from the polyurethane-based composition referred to herein as ‘Poly 3’, having properties set out in Table 3. In some preferred embodiments, body 101 of horseshoe 11 has physical parameters within ±25%, or preferably within ±10%, of one or more of the respective physical parameters recited in Table 3.

In particularly preferred embodiments the body of attachment 11 is formed from a material having a hardness between 55 D and 85 D as measured using the durometer scale either raw and/or after processing, including about: 56 D; 57 D; 58 D; 59 D; 60 D; 61 D; 62 D; 63 D; 64 D; 65 D; 66 D; 67 D; 68 D; 69 D; 70 D; 71 D; 72 D; 73 D; 74 D; 75 D; 76 D; 77 D; 78 D; 79 D; 80 D; 81 D; 82 D; 83 D; and 84 D. More preferably, said hardness is between about 60 D and about 80 D. In some particularly preferred embodiments, said hardness is between about 67 D and about 77 D.

It is preferred according to the invention that, although horseshoe 1 is flexible and/or mouldable, it is resistant to unwanted permanent deformation, e.g. ‘spreading’ as is known in the art. Materials with the above described characteristics, and in particular Poly 1, Poly 2, and Poly 3 materials, have been observed to be particularly desirable in this respect.

In some alternative embodiments wherein attachment 11 is formed from a material that is not polyurethane or a polyurethane-based polymer, the body of attachment 11 may be formed from natural and/or synthetic rubbers. For example, rubber-based compositions similar to as used in the production of tires may be used. Such embodiments may offer enhanced durability and/or protection of a horseshoe connected thereto.

It is generally preferred that attachment 11 is formed from material such that attachment 11 is flexible and mouldable when attached to a suitable horseshoe such as horseshoe 1 as hereinabove described.

However, it will be appreciated that, in alternative embodiments, attachment 11 may be relatively rigid. Such attachments are not suitable for use with horseshoes in circumstances where flexibility and/or mouldability is required. However, it will be appreciated that, in some circumstances, relatively rigid attachments may be desirable, for example to temporarily restrict or prevent flexibility and/or mouldability of horseshoe 1 described herein.

In one such alternative embodiment, attachment 11 may be constructed from a rigid metal such as stainless steel. By way of non-limiting example, such an alternative embodiment may be particularly desirable for use in ‘reining’. As will be understood by the skilled person, during reining, a horse's feet (particularly the back feet) slide or skid over the ground. The use of a rigid metal attachment 11, particularly with horseshoes attached to the back hoofs, may be desirable for this application to facilitate stability of the shoes and/or to provide increased durability of the attachment and/or protection of the shoes.

It will be appreciated that, in view of the unitary construction of attachment 11, attachment legs 201 and attachment bridge 301 extend continuously to form attachment body 101. Unitary construction of attachment 11 is particularly preferred, as, inter alia, this may contribute to desirable flexibility and/or mouldability of attachment 11.

However, it will be appreciated that in alternative embodiments, attachment body 101 may be formed from multiple components, for example attachment legs 201 and attachment bridge 301 may be formed from separate components.

It will also be appreciated that, in some embodiments, attachment 11 may be formed using ‘layers’ of material. By way of non-limiting example, a portion of attachment body 101 including attachment upper face 401 may be formed from polyurethane, and another portion of attachment body 101 including attachment lower face 501 may be formed from natural and/or synthetic rubber. In some such embodiments, lower face 50 may be formed from a rubber composition similar to used in tires (e.g. car tires), and may optionally include patterns of tread. Such embodiments may be herein referred to as ‘tire’ attachments.

As best seen in FIGS. 5, attachment bridge 301 forms the portion of attachment body 101 corresponding to points C₁ and C₂ on the outer edges, and points C₁′ and C₂′ on the inner edges, of attachment upper face 401 and attachment lower face 501.

It will be appreciated that corresponding points C₁ and C₁′, and C₂ and C₂′, are located a minimum distance apart across attachment body 101, as indicated by dashed lines in FIG. 5. It will be further understood that, as used generally herein, the minimum distance between such corresponding points across attachment body 101 represents the width of the attachment at a given position.

It will be appreciated that, in the embodiments described herein, attachment bridge 301 represents a central portion of about 0.25 of the total volume of attachment body 101. More generally, in preferred embodiments the bridge portion of attachments of the invention correspond to central portions of about 0.1 to about 0.5 of the volume of body 101, including about 0.15, about 0.20, about 0.25, about 0.30, about 0.35, about 0.40, and about 0.45.

As best seen in FIGS. 5, attachment legs 201 extend inwardly towards longitudinal axis B-B′ of attachment 11. Ends 211 of attachment legs 201 are oriented diagonally, with respective peaks 2101 located distal from peak 321 of bridge 301.

As best seen in FIG. 5, the width of attachment body 101 is at a maximum (referred to herein as Cₘₐₓ) at the mid-point 311 of attachment bridge 301. Furthermore, the width of attachment body 101 is at a minimum at peaks 2101 of ends 211 of attachment legs 201.

In some embodiments, for example as depicted in FIGS. 5 and 6, the width of attachment 11 gradually decreases from Cₘₐₓ until respective points (M₁) of attachment legs 201 near to ends 211, and then decreases more rapidly to form peaks 2101 of ends 211.

In some alternative embodiments, for example in some preferred embodiments wherein the attachment is particularly adapted for use with rear hoof horseshoe 1 of the invention depicted in FIGS. 3 and 4, the width of body 101 of attachment 11 fluctuates between Cₘₐₓ until respective points M₁, prior to rapid decrease to form peaks 2101.

As pictured, the ratio of the width at M₁ compared to the width at Cₘₐₓ is approximately 0.70-0.90. More generally, in attachments of the invention, without limitation thereto, the width at a point corresponding to M₁ as compared to the width at Cₘₐₓ is preferably between 0.65 to less than 1, including about: 0.70, 0.75, 0.80, 0.85, 0.90, and 0.95.

It will be appreciated that, in some alternative embodiments, attachment legs 201 do not comprise peaks 2101. In these embodiments, the point corresponding to M₁ may be at ends of the attachment legs.

It will be further appreciated that, in the embodiments of attachment 11 herein described, the average width of each of attachment legs 201 is less than the average width of attachment bridge 301. Generally, without limitation thereto, it is preferred that the average width of each of attachment legs 201 as compared to the average width of attachment bridge 301 is between about 0.65 to less than 1, including about: 0.70, 0.75, 0.80, 0.85, 0.90, and 0.95.

In the embodiments herein described, the ratio of the average width of attachment bridge 301 to the maximum length of attachment body 10 is about 0.30 to about 0.35. Generally, although without limitation thereto, it is preferred that said ratio is between about 0.2 to about 0.4, including about 0.2, about 0.25, about 0.3, and about 0.35. In particularly preferred embodiments, said ratio is greater than about 0.3. It is considered that embodiments with a ratio of greater than about 0.3 of the average width of the bridge 30 to the maximum length of the body 10 are particularly desirable in regard to flex, resilience, and/or durability of the attachment. This is believed to be particularly the case for ‘rear hoof’ attachments 11, although without limitation thereto.

Additionally, in the embodiments herein described, the ratio of the average width of attachment legs 201 to the maximum width of attachment body 101 is about 0.25. Generally, although without limitation thereto, it is preferred that said ratio is between about 0.15 to about 0.35, including about 0.2, about 0.25, and about 0.3.

In some preferred embodiments, the average thickness of attachment body 101 (referred to herein as UA), i.e. the average distance between attachment upper face 401 and attachment lower face 501, is less than about half of the maximum width of the bridge (Cₘₐₓ). Generally, without limitation thereto, it is preferred that said ratio is between about 0.05 to about 0.4, including about: 0.1, 0.15, 0.2, 0.25, 0.3, and 0.35. In some embodiments, said ratio is greater than about 0.19, preferably about 0.21. It is considered that said embodiments with a ratio of greater than about 0.19 or preferably about 0.21 of U_{A} to Cₘₐₓ may be, under at least certain circumstances, particularly desirable in regard to flex, resilience, and/or durability of the attachment,

Similarly, in some preferred embodiments, the maximum thickness of attachment body 101 (referred to herein as Uₘₐₓ), i.e. the maximum distance between attachment upper face 401 and attachment lower face 501, is less than about half of the maximum width of the bridge (Cₘₐₓ). Generally, without limitation thereto, said ratio is between about 0.1 to about 0.45, including about: 0.15, 0.20, 0.25, 0.30, 0.35, and 0.40. In some embodiments, said ratio is greater than about 0.19, preferably about 0.21. It is considered that said embodiments with a ratio of greater than about 0.19 or preferably about 0.21 of U_{A} to Cₘₐₓ may be, under at least certain circumstances, particularly desirable in regard to flex, resilience, and/or durability of the attachment,

In some embodiments, the thickness of attachment body 101 may vary at different regions of said body. In such embodiments, this variation in thickness may create inclination, slope, and/or elevation of attachment upper face 401 and/or attachment lower face 501, when attachment lower face 501 is engaged with the ground.

In one such embodiment, the thickness of attachment body 101 increases from peak 321 of attachment bridge 301 to ends 211 of attachment legs 201. Such embodiments may be referred to as ‘raised heel’ or ‘wedge’ attachments.

In another such embodiment, the thickness of attachment body 11 is increased relative to other regions of the body at a region including at least part of attachment bridge 301, and preferably including peak 321. Such an embodiment may be referred to as a ‘toe wear’ attachment.

As best seen in FIG. 5, in certain embodiments, the upper face 401 of the attachment comprises protrusions and indentations for engagement with a corresponding lower face of a horseshoe.

Specifically, attachment upper face 401 comprises protrusions 4011 which are substantially cylindrical in shape and are adapted to engage indentations 530 of lower face 50 of front hoof horseshoe 1 illustrated in FIGS. 1 and 2.

Attachment upper face 401 also comprises indentations 4012, which are adapted to engage tread 510 of lower face 50 of front hoof horseshoe 1.

Attachment upper face 401 also comprises protrusions 4013 which are adapted to engage channel indentations 520 of lower face 50 of front hoof horseshoe 1.

As best seen in FIG. 7, it will be further appreciated that respective portions of upper face 401 of attachment 11 are inclined to lie adjacent to portion 520 of lower face 50 which flanks mid-point 31 of bridge 30, and portion 530 of lower face 50 at ends 21.

With reference to FIG. 18, it will be appreciated that in embodiments of attachment 11 particularly adapted to connect with embodiments of horseshoe 1 comprising chamfer 540, such as Design 2 and Design 3 horseshoes 1, upper face 401 comprises protrusion 4014 adapted to engage with chamfer 540.

In some embodiments, attachment 11 may comprise catches or clips, similar as hereinabove described in relation to horseshoe 1. In some embodiments the catches or clips may extend from attachment upper face 401. In some embodiments the catches or clips may extend from respective outer edges of attachment upper face 401.

As depicted in FIG. 6, the surface of attachment lower face 501 is substantially smooth. However, it will be appreciated that the surface of attachment lower face 501 may alternatively comprise protrusions and or indentations, including particular patterns of tread adapted for particular applications.

The skilled person will readily appreciate that the particular shape of the lower face 501 of attachment 11 can be adjusted as desired for a given application. Without limitation thereto, some particular variations of shapes of attachment lower face 501, adapted for particular applications, are described as follows.

In some embodiments attachment lower face 501 may comprise an arrangement of raised projections or ‘studs’. By way of example, such embodiments may be advantageous for use on a hoof when traversing wet and/or muddy terrain. It will be appreciated that the projections or studs may be of an attachment of unitary construction, and formed from the same material as the body of the attachment. Alternatively, the projection or studs may be formed from a separate material. In some embodiments, the studs may be removable or separable from the attachment, e.g. by screwing or clipping.

In some embodiments, attachment lower face 501 may comprise studs, in conjunction with patterns of tread. For example, attachment lower face 501 may comprise studs towards ends 211 of attachment legs 201, in conjunction with tread at lower face 501 at bridge 301 and extending partially along attachment legs 201. Such treads may be curved (e.g. approximating a U-shape when attachment lower face 501 is viewed from above), or straight (e.g. extending approximately perpendicular with respect to longitudinal axis B-B′).

As best seen in FIG. 7, lower face 501 of attachment 11 is arcuate in longitudinal section. This arcuate shape of lower face 501 is considered to be particularly advantageous in assisting with pivoting or ‘roll over’ of a hoof during movement.

In alternative embodiments, a portion of attachment lower face 501 flanking the mid-point of attachment bridge 301, and/or portions at the ends of attachment legs 201, may be inclined to facilitate pivoting of the attachments, similar to as hereinabove described in regard to lower face 50 of horseshoe 1.

In some embodiments, a horseshoe attachment of the invention may further comprise a stabilizing portion connected to body 101.

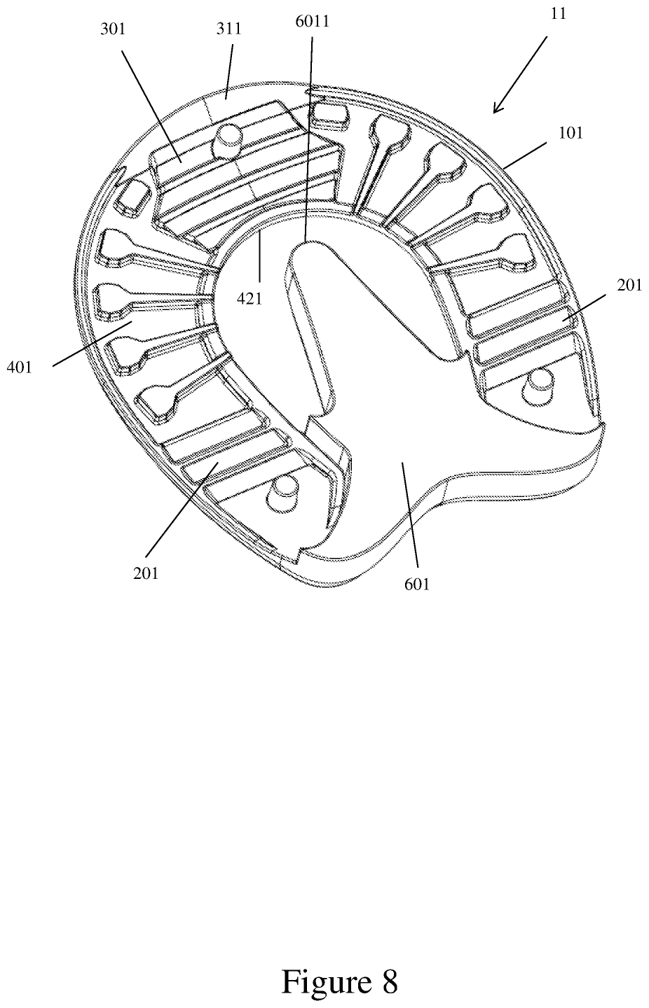

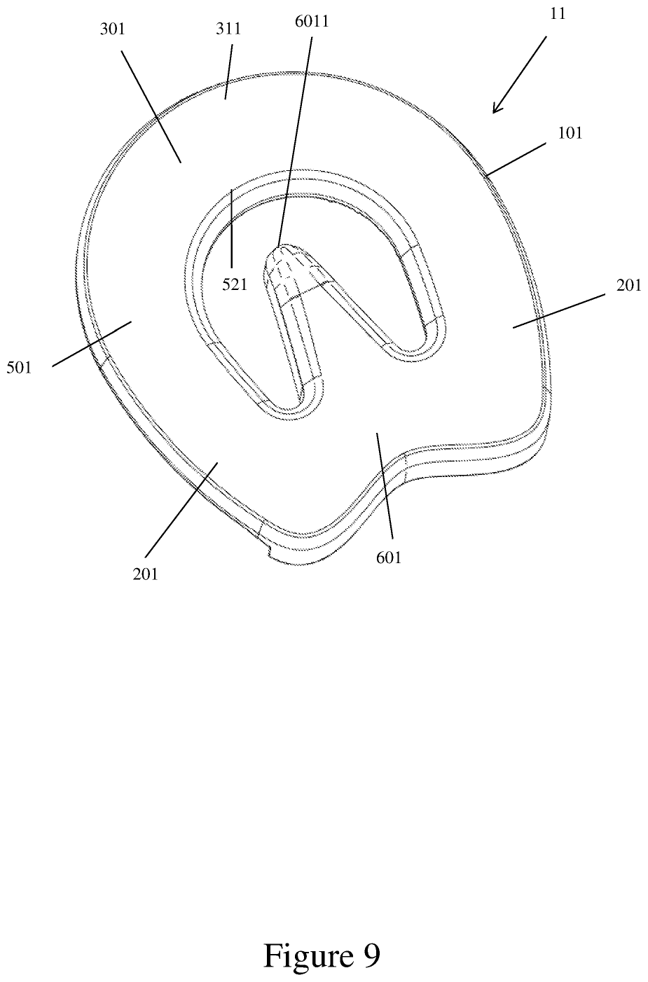

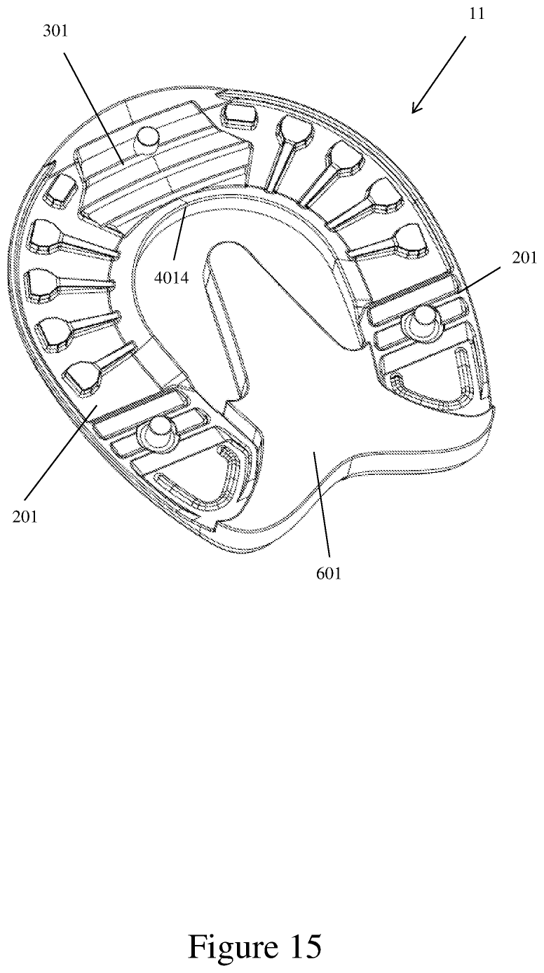

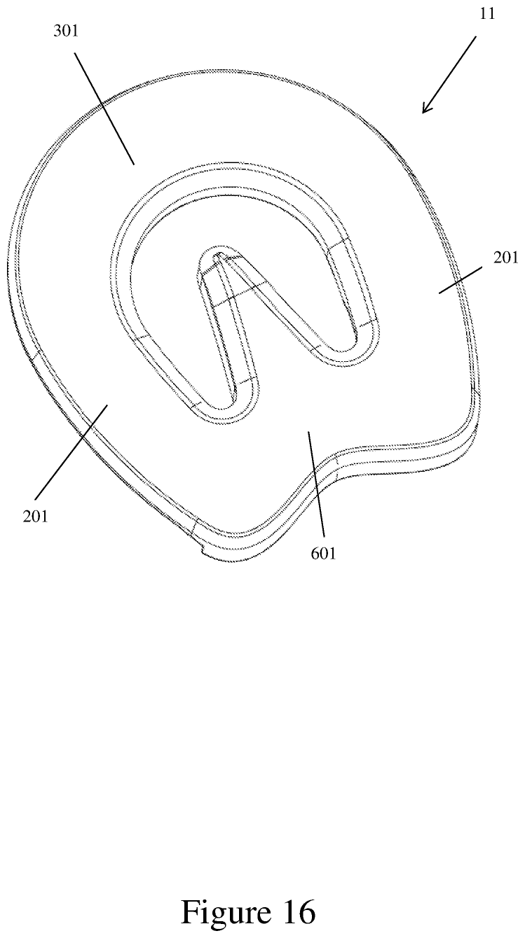

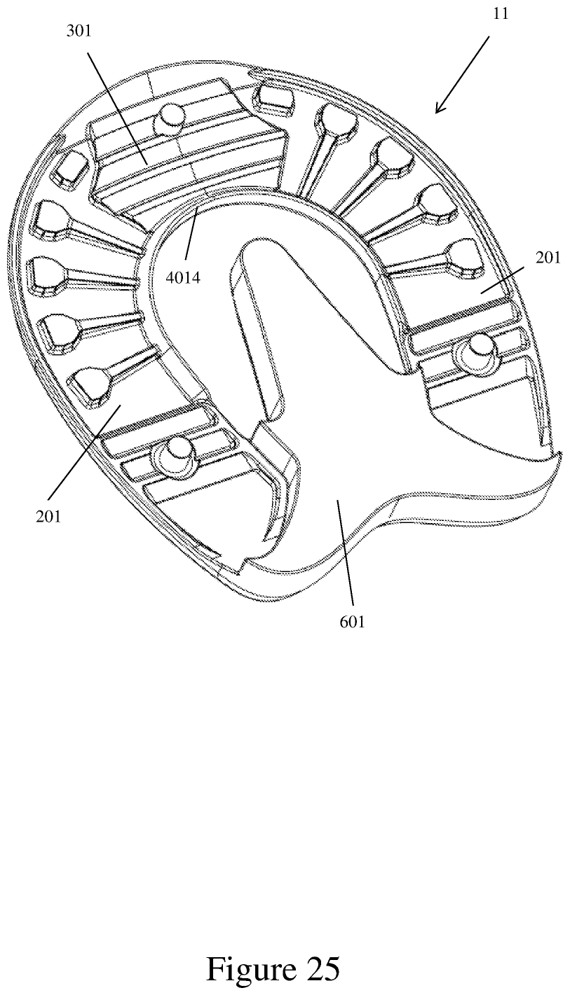

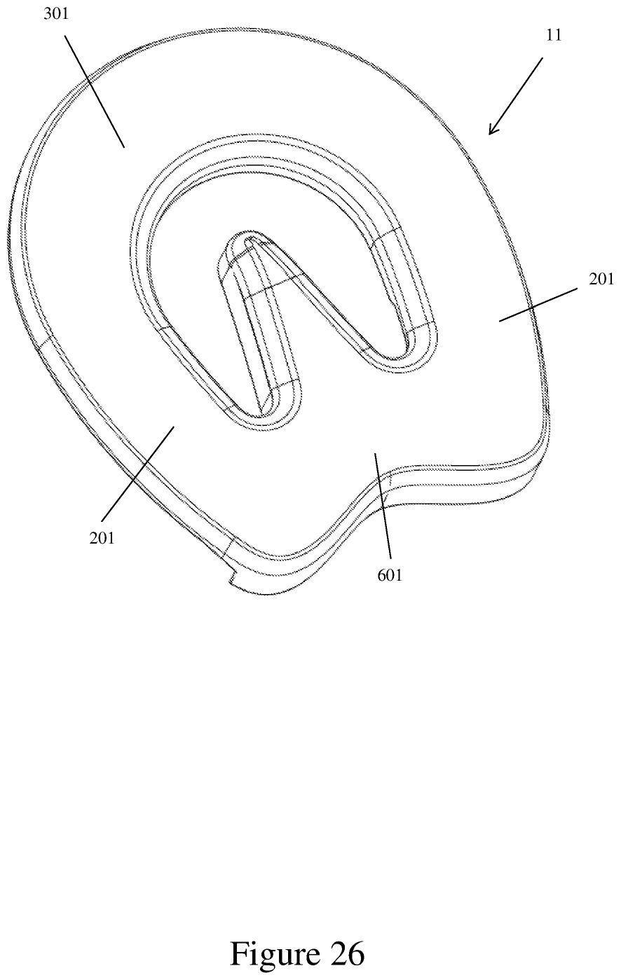

FIGS. 8-9; FIGS. 15-16; and FIGS. 25-26 illustrate horseshoe attachments 11 of the invention further comprising stabilizing portion 601. The attachments depicted in FIGS. 8-9 are particularly adapted for connection with Design 1 horseshoes 1. The attachments depicted in FIGS. 15-16 are particularly adapted for connection with Design 2 horseshoes 1. The attachments in FIGS. 25-26 are particularly adapted for connection with Design 3 horseshoes 1.

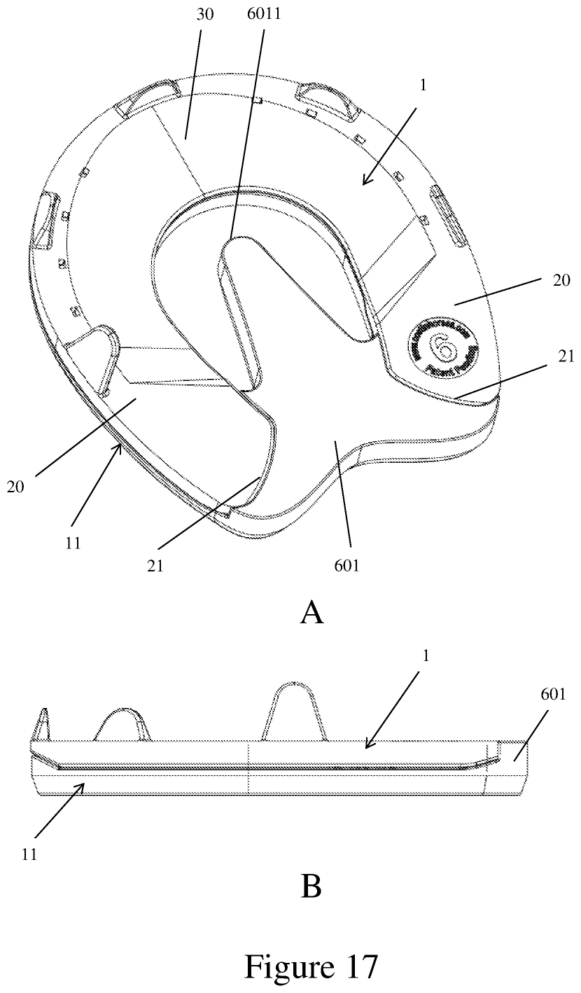

With reference to FIGS. 8-10 and FIGS. 15-18, and the following description, it will be appreciated that stabilizing portion 601 is in a form that may be referred to as a ‘heart bar’. It will be readily appreciated that other arrangements of stabilizing portions known to those skilled in the art, such as ‘egg bar’ stabilizing portions, may alternatively be used.

Furthermore, while such ‘heart bar’ and ‘egg bar’ stabilizing portions are typically adapted for supporting the foot, it will be appreciated that in other embodiments a stabilizing portion that is primarily adapted for stabilizing and or strengthening an attachment, and/or a horseshoe assembly comprising the attachment, may be used.

Stabilizing portion 601 is located between attachment legs 201 of attachment body 101. Specifically, stabilizing portion 601 links respective ends 211 of attachment body 101.

Stabilizing portion 601 connects legs 201 of attachment 11, and extends towards bridge 301 of attachment 11, comprising a peak 6011 near to inner edge 421 and 521 at the mid-point 311 of bridge 301.

As depicted in FIG. 8, stabilizing portion 601 is of a substantially uniform thickness. Furthermore, the average thickness of stabilizing portion 601 is substantially greater than the average thickness of attachment body 101.

As best seen in FIG. 8 and FIG. 12B, the average thickness of stabilizing portion 601 is greater than two times the average thickness of body 101 of attachment 11. In certain preferred embodiments, the ratio of the average thickness of a stabilizing portion to the average thickness of the attachment body is in the range of about 1.5 to about 4, including about 2, about 2.5, about 3, and about 3.5.

However, it will be appreciated that in certain other embodiments, the ratio of the average thickness of a stabilizing portion to the average thickness of the attachment body may be about 1, or even less than 1.

As depicted in FIG. 8, attachment body 101 and stabilizing portion 601 are together of unitary construction and formed from polyurethane. However, it will be appreciated that, in alternative embodiments, the body and the stabilizing portion may be formed from separate components. Such alternative embodiments may be desirable wherein a particular material that is different from the material used to construct attachment body 101 is required for stabilizing portion 601.

It will be appreciated that, additionally or alternatively to stabilizing portions, as hereinabove described, attachment 11 may comprise ‘extensions’, wherein body 101 extends in one or more directions beyond the respective inner and/or outer edges as depicted in the figures.

In certain embodiments, body 101 may outwardly extend from a side of the body, such that one of paired legs 201 has an average width that is greater than another of paired legs 201. Such embodiments may be referred to as ‘left side’ and ‘right side’ extension attachments, respectively. In certain embodiments, bridge 301, and optionally regions of paired legs 201 flanking bridge 201, may extend outwardly, such that the average width of the respective region of body 101 is increased. Such an embodiment may be referred to as a ‘toe extension’ attachment.

In use, attachment 11 can be fastened to a horseshoe using any suitable fastener. Suitable fasteners include mechanical fasteners including nails and screws, and chemical fasteners or adhesives, such as glues.

Preferably, said horseshoe is horseshoe 1 of the invention. As hereinabove described, attachment 11 is particularly adapted for attachment to horseshoe 1. However, it will be appreciated that attachment 11 need not necessarily be attached to a horseshoe of the invention, and can also be attached to any other horseshoe, as suitable.

In this respect, it will be appreciated that upper face 401 of attachment 11 is adapted for engagement of lower face 50 of horseshoe 1. In particular, attachment upper face 401 comprises protrusions and indentations which correspond to protrusions and indentations of lower face 50 of horseshoe 1. However, it will be readily appreciated that other shapes of the surface of upper face 401 of attachment 11 can be used, which may be particularly suitable for attachment to other horseshoes.

Furthermore, it will be readily appreciated that a ‘generic’ shape of upper face 401 can be used for attachments of the invention. Such a generic shape may be, for example, substantially flat, or include simple protrusions and/or indentations compatible for engagement with a range of conventional horseshoes.

In preferred embodiments, in use, attachment 11 is fastened to a lower surface of a horseshoe using a chemical adhesive. Preferred chemical adhesives include epoxy adhesives such as, by way of non-limiting example, ‘Equi-thane Super Fast™’ or similar.

Preferably, in embodiments wherein attachment 11 is fastened to horseshoe 1, the chemical adhesive is applied to protrusions 4011 of upper face 401 of attachment 11, and/or indentations 530 of lower face 50 of horseshoe 1.

In some embodiments, the chemical adhesive is additionally or alternatively applied to other protrusions and/or indentations of upper face 401 of attachment 11 and/or lower face 50 of horseshoe 1, including protrusions 510 and/or 4013, and/or indentations 520 and/or 4012.

The use of chemical adhesives as set forth above can be advantageous for efficiency of fastening and removal of attachments of the invention.

In use, attachments of the invention can be exchanged or replaced as desired, without requiring change of a horseshoe to which the attachment is attached. This can be particularly advantageous because, as hereinabove described, frequent replacement of horseshoes can cause damage to the hoof and/or foot. It will be appreciated that, by replacing an attachment connected to a horseshoe, rather than the horseshoe connected to the hoof, the damage to the hoof and/or foot can be substantially reduced.

As hereinabove described, the shape of the lower or ground engaging surface of the attachments of the invention can be varied, including to be adapted for particular activities. As such, use of attachments of the invention can be advantageous as this can allow for provision of a ground engaging surface that is adapted for a particular activity, without the need for replacing a horseshoe.

Furthermore, in use, where an attachment is substantially ‘worn’, e.g. wherein the material of the attachment has eroded such that the shape and/or thickness has substantially altered, and/or wherein the flexibility and/or mouldability properties of the attachment have changed (for example due to stress placed in the material, in use), the attachment can be easily replaced, without requiring replacement of a horseshoe.

The ability to replace attachments of the invention can be particularly advantageous for use with horseshoes of the invention, and other horseshoes constructed of materials such as plastic. Although horseshoes of the invention constructed from preferred material such as polyurethane as described herein typically demonstrate good durability in use, the use of said horseshoes may, at least in some circumstances, result in a need for more frequent replacement of the horseshoes as compared to conventional horseshoes constructed of rigid material such as steel or iron. It will be appreciated that use of an attachment with such horseshoes can reduce the frequency at which replacement of the horseshoe itself is required, with the attachment substantially protecting the horseshoe from wear.

In use, when suitably fastened to a flexible horseshoe such as horseshoe 1 described herein, attachment 11 is preferably constructed of a material such that attachment 11 flexes with the natural flexing and widening of the hoof when engaged with the ground. Additionally, when attached to a suitably mouldable horseshoe, such as horseshoe 1 described herein, attachment 11 can preferably mould to the shape of the horseshoe, which itself may mould to the shape of the hoof.

Flexing and moulding of attachment 11 is particularly advantageous, as this allows natural shock absorption of the hoof to occur when the attachment is attached to a suitably flexible and/or mouldable horseshoe such as horseshoe 1 described herein.

As hereinabove described, the embodiments of attachment 11 illustrated in FIG. 5 and FIG. 6, and preferred other embodiments of the horseshoe of the invention, have particular parameters in relation to the width of the body of the horseshoe at bridge 301 as compared to each of legs 201. These parameters are considered to be particularly advantageous for flexibility and mouldability of the attachment when attached to a suitable horseshoe such as horseshoe 1 described herein.

Furthermore, as hereinabove described, the embodiments of attachment 11 illustrated in FIG. 5 and FIG. 6, and preferred other embodiments of the horseshoe of the invention, have particular parameters in relation to the thickness of the attachment. These parameters are considered to be particularly advantageous for flexibility and mouldability of the horseshoe when attached to a suitable horseshoe such as horseshoe 1 described herein.

However, although construction of attachment 11 of a suitable material allowing flexibility and/or mouldability is preferred, it will be appreciated that in other embodiments, attachment 11 may be constructed of a relatively rigid material. In use, when such alternative embodiments of attachment 11 are suitably connected to a flexible and/or mouldable horseshoe, these embodiments will restrict or prevent flexing and/or moulding of the horseshoe.

In use, the arcuate shape of lower face 501 of attachment 11 in longitudinal section, as depicted in FIG. 7B, facilitates pivoting of the hoof against the ground. The inclusion of such an arcuate shape of lower face 501 is considered advantageous as it may further facilitate shock absorption by the hoof when the attachment is attached to a suitable horseshoe such as horseshoe 1 described herein, and may assist ‘roll over’ of a hoof during movement, facilitating natural movement of the hoof.

Similarly, where inclined portions are included flanking the peak 321 of bridge 300, and/or at the ends 211 of legs 201, as may be included in certain embodiments of attachment 11, these may similarly assist with shock absorption and/or natural movement of the hoof.

As herein described, in certain embodiments, attachment 11 may comprise extensions and or variations in thickness. Such variations may be particularly adapted for use by a horse with certain conditions, or with irregular gait, although without limitation thereto.

By way of example, wedge or heel elevation attachments can adjust the mechanics of hoof and leg when contacting the ground during movement, and may assist with treating lameness. Furthermore, ‘extension’ type attachments can be used to treat conformational issues, e.g. during development of foals and yearlings.

Furthermore, as hereinabove described, in some embodiments attachment 11 may comprise catches or clips. In use, such clips may be fastened (e.g. using a suitable glue) to a horseshoe and/or the upper surface of a hoof, to assist with stable fastening of the attachment.

In particular regard to embodiments of attachment 11, such as depicted in FIGS. 8-10, wherein the attachment further comprises stabilizing portion 601, in use, stabilizing portion 601 is adapted to lie against the frog of a horse's foot.

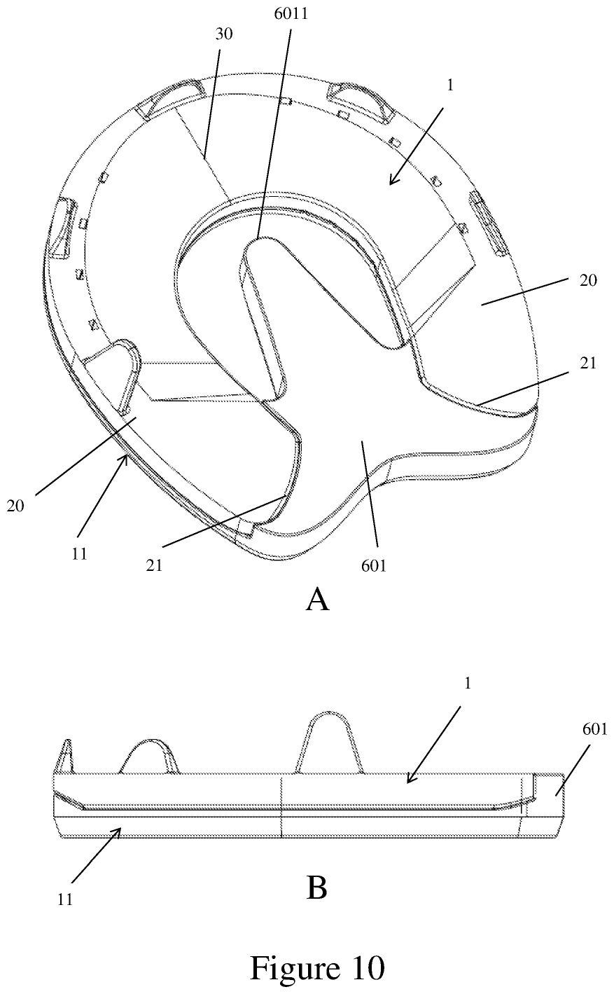

In this regard, attachment 11 comprising stabilizing portion 601 is particularly adapted for use with horseshoe 1. As illustrated in FIG. 10, when attached to horseshoe 1, an upper face of stabilizing portion 601 lies in substantially the plane as upper face 40 of horseshoe 1. As a result of this arrangement, in normal use, when horseshoe 1 is fastened to a hoof of a horse, and attachment 11 comprising stabilizing portion 601 is fastened to horseshoe 1, stabilizing portion 601 lies against the frog of the horses foot.

In use, when attachment 11 is attached such that stabilizing portion 601 lies against the frog of a horses foot, stabilizing portion 601 applies pressure to the frog. As will be understood by the skilled person, the use of an attachment comprising stabilizing portion 601 can be advantageous for a horse with particular conditions such as laminitis.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

The above description of various embodiments of the present invention is provided for purposes of description to one of ordinary skill in the related art. It is not intended to be exhaustive or to limit the invention to a single disclosed embodiment.

As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

### TABLES

TABLE 1
Physical properties of Poly 1 (marketed as Wanthane ® WHT-
1172) after injection moulding to form body 10 of horseshoe
1, measured according to ASTM methods.

| Property | Testing Method | Result |
|---|---|---|
| Hardness, D | ASTM D2240-05 | 77 |
| Elongation, % | ASTM D412-06a | 318 |
| 100% stretching strength, Mpa | ASTM D412-06a | 33.8 |
| 300% stretching strength, Mpa | ASTM D412-06a | 45.4 |
| Tensile Strength, Mpa | ASTM D412-06a | 47.9 |
| Tear Strength, N/mm | ASTM D624-00 | 282.4 |

TABLE 2
Physical Properties of Poly 2 (marketed as Elastollan ® S 64 D)
as provided in the manufacturer's General Product Information, dated November
2007. As stated in the General Product Information, test specimens are cut
from plates of thickness 2 mm and 6 mm which are injection moulded and then
tempered for 20 hrs at 100° C. Before injection moulding granules are
pre-dried to water content of ≤0.02%. Mechanical testing is done at 23°
C. ± 2° C. and 50% ± 6% rel. humidity. The stated values are typical test results.

| | | | | Test method |
|---|---|---|---|---|
| Property | | Unit | Value | according to |
| Hardness | | Shore D | 64 | DIN 53505 |
| Density | | g/cm³ | 1.26 | DIN EN ISO 1183-1-A |
| Tensile strength | | MPa | 45 | DIN 53504-S2 |
| Elongation at break | | % | 450 | DIN 53504-S2 |
| Stress at 20% elongation | | MPa | 22 | DIN 53504-S2 |
| Stress at 100% elongation | | MPa | 23 | DIN 53504-S2 |
| Stress at 300% elongation | | MPa | 38 | DIN 53504-S2 |
| Modulus of elasticity - tensile test | | MPa | 410 | DIN EN ISO 527 |
| Tear strength | | N/mm | 200 | DIN ISO 34-1Bb |
| Abrasion loss | | mm³ | 25 | DIN ISO 4649-A |
| Compression set at room temperature | | % | 45 | DIN ISO 815 |
| Compression set at 70° C. | | % | 55 | DIN ISO 815 |
| Notched impact strength (Charpy) + | +23° C. | kJ/m² | 140 | DIN EN ISO 179-1 |
| | −30° C. | kJ/m² | 4 | |

TABLE 3
Physical Properties of Poly 3 (marketed as Elastollan ®
C 60 D) as provided in the manufacturer's General Product Information.
Testing was performed under similar conditions as noted for table 1.

| | Metric | | English | | Comments |
|---|---|---|---|---|---|
| Physical Properties | | | | | |
| Density | 1.24 | g/cc | 0.0448 | lb/in³ | ASTM D792 |
| Mechanical Properties | | | | | |
| Hardness, Shore D | 60 | | 60 | | ASTM D2240 |
| Tensile Strength, Ultimate | 43.0 | MPa | 6240 | psi | ASTM D412 |
| Tensile Strength, Yield | 24.0 | MPa | 3480 | psi | ASTM D-412 |
| | @Strain 100% | | @Strain 100% | | |
| | 42.0 | MPa | 6090 | psi | ASTM D-412 |
| | @Strain 300% | | @Strain 300% | | |
| Elongation at Break | 375% | | 375% | | ASTM D412 |
| Tear Strength | 215 | kN/m | 1230 | pli | ASTM D624 |
| Taber Abrasion, mg/1000 | 50 | | 50 | | H-18 wheel; ASTM D-1044. |
| Cycles | | | | | |
| Tensile Set | 100% | | 100% | | At break; ASTM D-412 |
| Electrical Properties | | | | | |
| Comparative Tracking Index | >=600 | V | >=600 | V | DIN/IRC 112 |

TABLE 4
Observations of beneficial effects of horseshoes of the invention.

| | Horse | | |
|---|---|---|---|
| Horse name | characteristics | Purpose | Observation |
| Sacromonte | 4 year old | Flat | Career results: 18 starts for 2 wins, 6 seconds, 1 third. Total prize |
| | gelding; | racing | money AU$39000. Using steel or aluminium shoes: 2 placings from |
| | grey/brown; | and race | 7 starts - ran second on 5 Jun. 2016 on a wet track; and second on |
| | foaling date | training | 25 June on a wet rack. The owners believed he was a wet track only |
| | 27 Oct. 2012 | | horse, as it was observed that he could not stretch out his stride |
| | | | properly on hard tracks. Using horseshoes of the invention: 7 |
| | | | placings from 11 starts - ran second on 25 Oct. 2016 on a hard |
| | | | track; won in late 2016 on a hard track; either won or placed in 4 |
| | | | consecutive starts all on hard track during late 2016 and early 2017; |
| | | | and ran second on a hard track during mid-2017. |
| Sirocan | 7 year old | Flat | Using aluminium shoes: 1 win from 4 starts. Obvious signs of heel |
| | gelding; grey; | racing | soreness and difficult temperament during training. Using |
| | large horse (16 | and race | horseshoes of the invention: 1 win from 1 start. Greatly improved |
| | hands); foaling | training | temperament and no sign of shin soreness during training. |
| | data 23 Sept. 2009 | | |
| Zenkali | 6 year old mare; | Flat | Using aluminium shoes: 0 placings from 6 starts. Obvious signs of |
| | foaling date | racing | shin soreness during training. Using horseshoes of the invention: 1 |
| | 8 Nov. 2010 | and race | win from 1 start. No sign of shin soreness during training. |
| | | training | |
| High Cloud | 5 year old mare | Harness/ | Using aluminium shoes: 3 wins from around 65 starts. Consistent |
| Lass | | trotting | and obvious issues with jarring up. Using horseshoes of the |
| | | racing | invention: 1 third (11 Apr. 2017), 1 win (16 Apr. 2017), and 1 |
| | | and | second (18 Apr. 2017), from 3 starts. No issues with jarring up and |
| | | training | gained a 10 second improvement to personal best during training. |
| Rapid Frost | 3 year old gelding | Race | Using steel or aluminium shoes: Chronic issues with sore front legs |
| | | training | during training; ‘shelly’ feet with thin and cracked hoof walls. Using |
| | | | horseshoes of the invention: No obvious front leg soreness, and |
| | | | improved front hoofs. |
| Caesar (race | Thoroughbred; | Racing | Using steel shoes: Chronic issues with lameness. Using horseshoes |
| name | by Minardi (US) | and | of the invention: Completely sound. Much lighter and freer in |
| ‘Believe in | out of Leelinchin | eventing | paces. |
| Heart’) | (AU); born 2008; | | |
| | dapple grey; 15.3 | | |
| | hands | | |
| Saffron | Stock horse × | Eventing | Using steel shoes: Did not tolerate shoeing and went unshod for ~8 |
| | thoroughbred; | | years. Using horseshoes of the invention: Tremendous |
| | 15.1 hands | | improvement in dressage. No longer hobbles or steps up short. |
| | | | Tracks up from behind. |
| Avispa | Originally bred | Eventing | Using steel shoes: Presented with a bad knee (swollen with a lot of |
| | for polo; 16.1 | | fluid) and a shin splint. Leg x-rayed but no breaks seen. Also, hoofs |
| | hands; bay; ~9 | | very brittle. Using horseshoes of the invention: Knee improved |
| | years old | | very rapidly with swelling and fluid disappearing. Also, hoofs |
| | | | improved, particularly when horseshoe was applied by gluing. |

1. A horseshoe for flexible and/or mouldable engagement with a hoof, a body of the horseshoe comprising a bridge connecting two legs, wherein the horseshoe is of unitary construction and formed from a material having a hardness of about 55 D to about 80 D as measured using durometer scale.

2. The horseshoe of claim 1, wherein the horseshoe is formed from a material having a hardness of about 67 D to about 77 D.

3. The horseshoe of claim 1, wherein the horseshoe is formed from a polyurethane, or a material comprising polyurethane.

4. The horseshoe of claim 1, wherein the legs extend inwardly towards a longitudinal axis of the horseshoe.

5. The horseshoe of claim 1, wherein an average width of the bridge is greater than an average width of each of the two legs.

6. The horseshoe of claim 5, wherein the bridge is an arcuate bridge, and a width of the horseshoe decreases from a peak of the arcuate bridge, to ends of the legs.

7. (canceled)

8. (canceled)

9. The horseshoe of claim 1, wherein a portion of an upper face of the horseshoe comprises an inclination oriented downwardly towards an inner edge of the upper face, wherein said portion extends over at least part of the bridge of the horseshoe.

10. The horseshoe of claim 1, wherein a lower face of the horseshoe comprises one or more protrusions and/or indentations.

11. The horseshoe of claim 1, wherein, at a portion flanking a mid-point of the bridge, a lower face of the horseshoe is inclined to facilitate pivoting of the horseshoe about an outer edge of the horseshoe.

12. The horseshoe of claim 1, wherein, at respective ends of the legs, a lower face of the horseshoe is inclined to facilitate pivoting of the horseshoe about the ends of the legs.

13. The horseshoe of claim 1, wherein the body of the horseshoe comprises one or more apertures or channels extending between a lower face and an upper face of the horseshoe

14. (canceled)

15. The horseshoe of claim 1, further comprising one or more clips extending from an upper face of the horseshoe, and located at or near an outer edge of the horseshoe.

16. The horseshoe of claim 1, wherein a lower face of the horseshoe comprises one or more indentations for connection of an attachment to the horseshoe.

17. (canceled)

18. (canceled)

19. An attachment for flexible and/or mouldable engagement of a horseshoe, wherein a body of the attachment comprises a bridge connecting two legs.

20. The attachment of claim 19, wherein the legs extend inwardly towards a longitudinal axis of the attachment.

21. The attachment of claim 19, wherein an average width of the bridge is greater than an average width of each of the two legs.

22. (canceled)

23. (canceled)

24. (canceled)

25. (canceled)

26. The attachment of claim 19, wherein an upper face of the attachment comprises one or more protrusions and/or indentations for engagement with a corresponding lower face of a horseshoe.

27. (canceled)

28. (canceled)

29. (canceled)

30. The attachment of claim 19, wherein the body of the attachment is formed from a material having a hardness of about 55 D to about 80 D, as measured using durometer scale.

31. (canceled)

32. (canceled)

33. The attachment of claim 19, wherein the attachment comprises a stabilizing portion connected to the body.

34. (canceled)

35. (canceled)

36. An assembly of the horseshoe of claim 1, wherein a body of the attachment comprises a bridge connecting two legs.

37. (canceled)

38. (canceled)

39. (canceled)

40. (canceled)

41. (canceled)

42. (canceled)

43. (canceled)

44. (canceled)
